(19) United States
(12) Patent Application Publication
(10) Pub. No.: US 2026/0322667 A1
(43) Pub. Date: Oct. 15, 2026

(54) RANDOM ACCESS PROCEDURE FOR AMBIENT INTERNET OF THINGS

(71) Applicant: Intel Corporation, Santa Clara, CA (US)

(72) Inventors: Gang Xiong, Beaverton, OR (US); Daewon Lee, Portland, OR (US); Debdeep Chatterjee, San Jose, CA (US)

(21) Appl. No.: 19/484,769

(22) PCT Filed: Dec. 18, 2024
(86) PCT No.: PCT/US2024/060735

§ 371 Date: Nov. 14, 2025

Related U.S. Application Data
(60) Provisional application No. 63/627,437, filed on Jan. 31, 2024.
(60) Provisional application No. 63/627,603, filed on Jan. 31, 2024.

(51) Int. Cl. H04L 27/26; H04L 5/00; H04W 74/00; H04W 74/0838; H04W 84/18

(52) U.S. Cl. CPC H04L 27/26025; H04L 5/0007; H04W 74/002; H04W 74/0838; H04W 84/18

(57) ABSTRACT

Various embodiments herein provide techniques related to co-existence of ambient internet of things (A-IoT) devices with cellular network devices. Some embodiments may relate to physical channel structure and/or signaling between such devices. Some embodiments may relate to a random access channel (RACH) procedure to be performed by an A-IoT device. Other embodiments may be described and/or claimed.

### CROSS REFERENCE TO RELATED APPLICATION

The present application claims priority to U.S. Provisional Patent Application No. 63/627,437, which was filed Jan. 31, 2024; and to U.S. Provisional Patent Application No. 63/627,603, which was filed Jan. 31, 2024.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example random access channel (RACH) procedure for new radio (NR) cellular networks, in accordance with various embodiments.

FIG. 2 illustrates example topologies (Topology 1 and Topology 2) for ambient internet of things (A-IoT) applications, in accordance with various embodiments.

FIG. 3 illustrates an example random access procedure for A-IoT with Topology 1 from FIG. 2, in accordance with various embodiments.

FIG. 4 illustrates an example random access procedure for A-IoT, in accordance with various embodiments.

FIG. 5 illustrates an alternative example random access procedure for A-IoT, in accordance with various embodiments.

FIG. 6 illustrates an example orthogonal cover code (OCC) for the transmission of a data packet that includes a contention resolution identifier (ID), in accordance with various embodiments.

FIG. 7 illustrates an example message format for use in the procedure of FIG. 3, in accordance with various embodiments.

FIG. 8 illustrates an example random access procedure for A-IoT with Topology 2 of FIG. 2, in accordance with various embodiments.

FIG. 9 illustrates an example symbol or chip duration for a physical channel and signal for A-IoT, in accordance with various embodiments.

FIG. 10 illustrates an example of handling a longer cyclic prefix (CP) duration for A-IoT, in accordance with various embodiments.

FIG. 11 illustrates an example of options of a time domain resource for a physical channel for A-IoT based on a subframe, in accordance with various embodiments.

FIG. 12 illustrates an example of options of a time domain resource for a physical channel for A-IoT based on a bundled subframe, in accordance with various embodiments.

FIG. 13 illustrates an example of a physical channel structure with two parts, in accordance with various embodiments.

FIG. 14 illustrates an example option for a physical channel structure with three parts, in accordance with various embodiments.

FIG. 15 illustrates an alternative example option for a physical channel structure with three parts, in accordance with various embodiments.

FIG. 16 schematically illustrates a wireless network in accordance with various embodiments.

FIG. 17 schematically illustrates components of a wireless network in accordance with various embodiments.

FIG. 18 is a block diagram illustrating components, according to some example embodiments, able to read instructions from a machine-readable or computer-readable medium (e.g., a non-transitory machine-readable storage medium) and perform any one or more of the methodologies discussed herein.

FIG. 19 illustrates a network in accordance with various embodiments.

FIG. 20 depicts an example procedure for practicing the various embodiments discussed herein.

FIG. 21 depicts another example procedure for practicing the various embodiments discussed herein.

FIG. 22 depicts another example procedure for practicing the various embodiments discussed herein.

FIG. 23 depicts another example procedure for practicing the various embodiments discussed herein.

FIG. 24 depicts another example procedure for practicing the various embodiments discussed herein.

FIG. 25 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B). Unless used differently herein, terms, definitions, and abbreviations may be consistent with terms, definitions, and abbreviations defined in 3GPP TR 21.905 v 16.0.0 (2019-06)

### A-IoT Random Access

Internet of Things (IoT) has evolved to encompass a diverse range of applications, including smart home, smart city, healthcare monitoring, etc. In third generation partnership project (3GPP) systems and standards, various connectivity technologies tailored to IoT requirements were introduced. In particular, Low Power, Wide-Area (LPWA) Technologies such as Narrowband IoT (NB-IoT) and long term evolution (LTE)-machine type communication (MTC), which may be referred to as LTE-MTC or LTE-M, were specified at least in part to address the specific needs of low-power devices, extending the battery life of IoT devices and enabling their use in remote or hard-to-reach locations.

Given that legacy technologies may not be able to meet all the requirements of target use cases such as asset identification, inventory, sensing, etc., Ambient Internet of Things (A-IoT) technology may be used in 3GPP release-19(Rel-19) systems or specifications to open additional markets or capabilities within 3GPP systems, whose number of connections and/or device density can be orders of magnitude higher than legacy 3GPP IoT technologies. The additional IoT technology may provide complexity and power consumption orders of magnitude lower than the legacy 3GPP LPWA technologies and may address use cases and scenarios that cannot otherwise be fulfilled based on legacy 3GPP LPWA IoT technologies.

In particular, the A-IoT devices typically have limited size with no energy storage capability or with limited energy storage that do not need to be replaced or recharged manually. In this case, the output power of energy harvester is typically from 1 microwatt (μW) to a few hundreds of μW. Legacy cellular devices may not work well with energy harvesting due to their peak power consumption of higher than 10 milliwatts (mW).

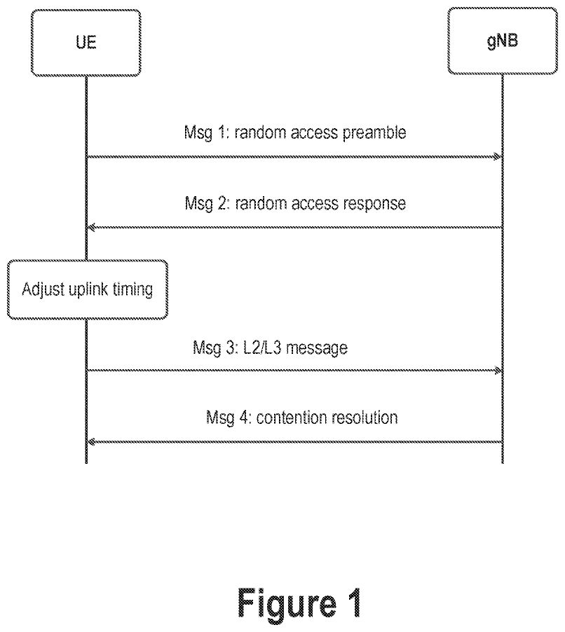

In 3GPP new radio (NR) release-15(Rel-15), a 4-element random access channel (RACH) procedure was defined. FIG. 1 illustrates an example of the 4-element RACH procedure for initial access. In the first Element, a user equipment (UE) may transmit a physical random access channel (PRACH) in the uplink by randomly selecting one preamble signature, which may allow a base station such as a gNodeB (gNB) to estimate the delay between gNB and UE for subsequent uplink (UL) timing adjustment. Subsequently, in the second element, the gNB feedbacks the random access response (RAR) which carries timing advanced (TA) command information and uplink grant for the uplink transmission in the third element. The UE expects to receive the RAR within a time window, of which the start and end are configured by the gNB via system information block (SIB).

However, for A-IoT devices, which may have extremely low power consumption, the legacy random access procedure as defined in NR may not be directly applied. For instance, A-IoT devices may only backscatter the carrier wave signal transmitted by emitter, where amplitude, frequency, and/or phase of the incoming signal may be changed for modulation. In addition, the communication range between reader and A-IoT devices can be limited, which indicates that PRACH-like signal may not be needed during random access procedure. Hence, it may be desirable to define a random access procedure for A-IoT applications. Various embodiments herein relate to a random access procedure for A-IoT.

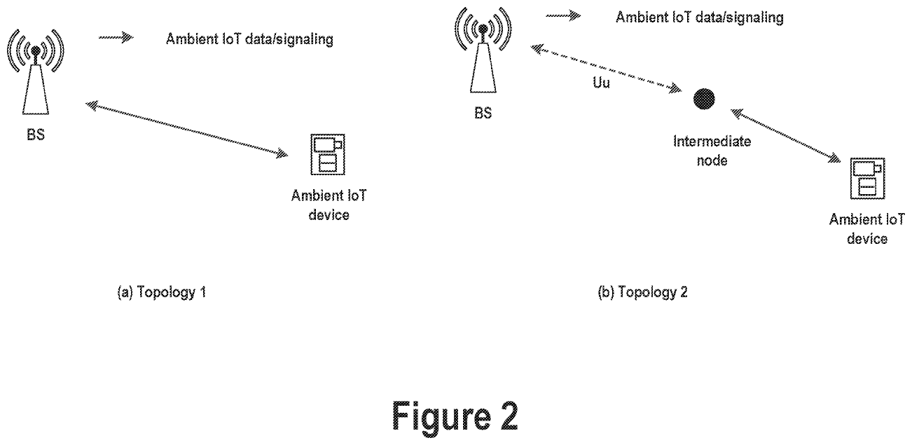

Two example topologies are considered for A-IoT applications. FIG. 2 illustrates examples of the Topology 1 and 2 for A-IoT applications. In particular,
Topology 1: the Ambient IoT device directly and bidirectionally communicates with a base station. The communication between the base station and the ambient IoT device includes Ambient IoT data and/or signalling.
Topology 2: the Ambient IoT device communicates bidirectionally with an intermediate node between the device and base station, where the intermediate node can be a relay, integrated access/backhaul (IAB) node, UE, repeater, etc. which is capable of Ambient IoT. The intermediate node transfers Ambient IoT data and/or signalling between the base station (BS) and the Ambient IoT device.

Example embodiments of a random access procedure for A-IoT are provided as follows:

In one embodiment, for Topology 1 for A-IoT applications, where A-IoT devices directly communicate with reader, random access procedure may include one or more of the following elements.
0: reader may send select command to inform a set of A-IoT devices for random access procedure and certain system information.
   In some aspects, the reader may select different set of A-IoT devices for query procedure.
   1: reader may send query command to provide additional information for the set of A-IoT devices to perform random access procedure.
   2: one or more A-IoT device that are in the set of A-IoT devices from Element 0 may generate a contention resolution identifier (ID) which is carried by the data packet. The contention resolution ID may be N bits, which may be randomly generated by the A-IoT devices, where N may be predefined in the specification. One or more A-IoT device may generate a random backoff counter value, which is used to determine the delay for the response from A-IoT to reader.
      Contention resolution ID could be equal to the random backoff value, or random backoff value could be a subset of the contention resolution ID, where part of the contention resolution ID is determined the backoff value.
   3: when reader receives the contention resolution ID from the A-IoT devices, the reader may send a command with acknowledgement which may also include the received contention resolution ID from the A-IoT devices.
   4: when A-IoT receives the acknowledgment message from the reader, the A-IoT devices check whether the received contention resolution ID matches with the contention resolution ID that the A-IoT devices send in the Element 3. If they are matched, the A-IoT devices may send an acknowledgement message to the reader.

In some aspects, after an A-IoT device completes the random access procedure, the A-IoT device may be in a different state. In this case, when the reader including gNB or UE performs query for the same set of A-IoT devices, the A-IoT device may not initiate the random access procedure.

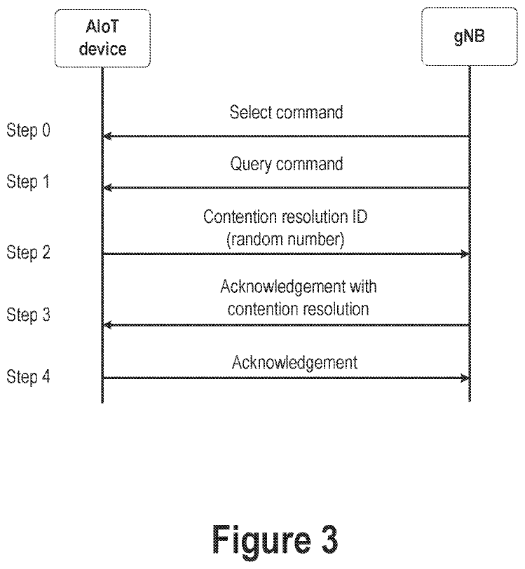

FIG. 3 illustrates one example of random access procedure for A-IoT with topology 1.

In one embodiment, in Element 1, the query command may be transmitted periodically when activated. The periodicity and/or offset of the query command may be predefined in the specification or indicated by the select command in the element 0. The periodicity and/or offset of query command transmission may be defined in the orthogonal frequency division multiplexing (OFDM) symbol, slot or subframe level, which may be determined in accordance with the subcarrier spacing that is predefined in the specification or indicated in the select command in Element 0.

In some aspects, when one or more types of A-IoT devices are in the same system, query command may also include an indication on which one of the A-IoT device types may perform the random access procedure.

In addition, query command may include a backoff indicator or scaling factor for backoff indication. In some aspects, backoff indicator or scaling factor for backoff indication may be updated from different transmission occasions of query command.

In one embodiment, in Element 2, A-IoT device may randomly generate a counter value within a range of [0, K], where K can be determined in accordance with the indicated backoff indication value. In one example, K=2^{N}−1 and N is the value indicated in the query command in Element 2.

The counter value is decremented by 1 for each query command. When the counter value reduces to 0, the A-IoT device starts to transmit the message in Element 2. In case when the A-IoT device receives an updated query command, including a new backoff indication, the A-IoT resets the counter value which is generated in accordance with the new backoff indication.

Alternatively, the randomly generated counter value is decremented by 1 for each unit backoff time passed after the query command or a reference time after the query command. Once the counter backoff time is 0, A-IoT device transmits the response to reader. The randomly delay response potentially allows resolution of conflict among responses from one or more A-IoT devices being queried.

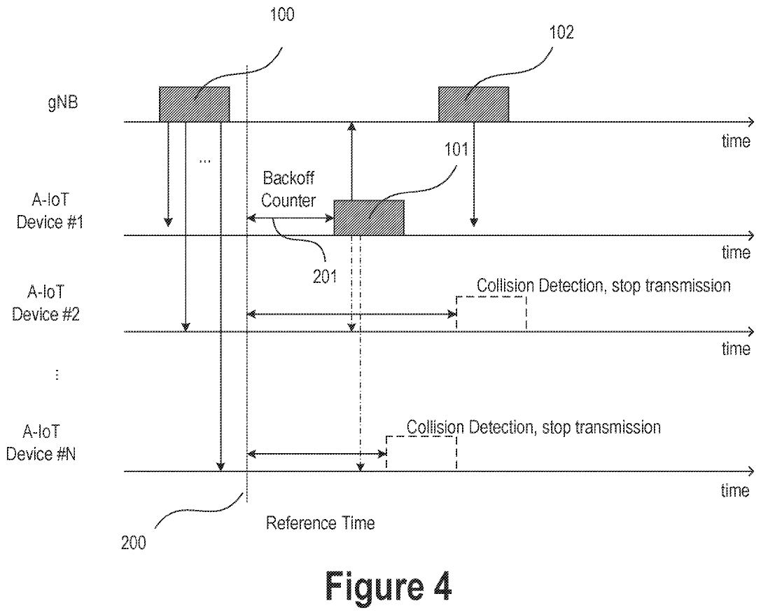

FIG. 4 illustrates one example of random access procedure for A-IoT. In the figure, after reader sends query message in Element 1, A-IoT device #1 initiates the random access procedure and performs random backoff based on generated backoff counter. If other A-IoT devices in the same set of A-IoT that are indicated in the Element O detect the transmission from the A-IOT device #1, the other A-IoT devices stop the transmission.

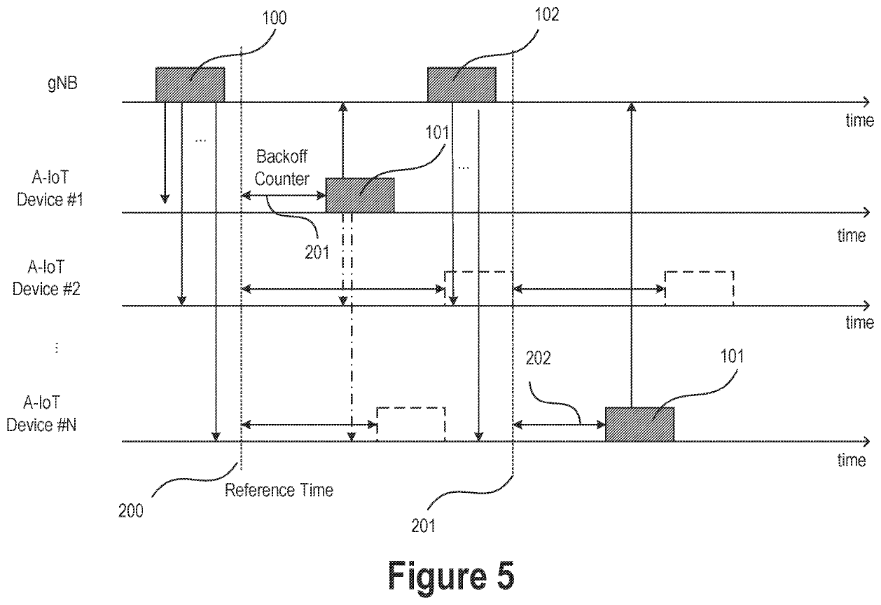

FIG. 5 illustrates one example of random access procedure for A-IoT. In the figure, after reader sends query message in Element 1, A-IoT device #1 initiates the random access procedure and performs random backoff based on generated backoff counter. If the random access procedure is successful for A-IoT device #1, the A-IoT device #1 may be transitioned to a different state. In this case, when reader sends another query message for the same set of A-IoT devices, the A-IoT device #1 does not re-initiate the random access procedure. Other A-IoT devices in the set of A-IoT devices may continue to perform random backoff for random access procedure.

In some aspects, the A-IoT device may include the A-IoT device type and/or A-IoT device capability information in the Element 3 together with contention resolution ID.

In some aspects, a set of orthogonal cover codes (OCC) may be defined in the specification, which can be applied to the transmission of the message that contains the contention resolution ID from the A-IoT device. In this case, the A-IoT device may randomly select one OCC from the set of OCCs for the transmission of message in Element 2. The selected OCC may be indicated in the control message that is transmitted before the data packet that contains the contention resolution ID.

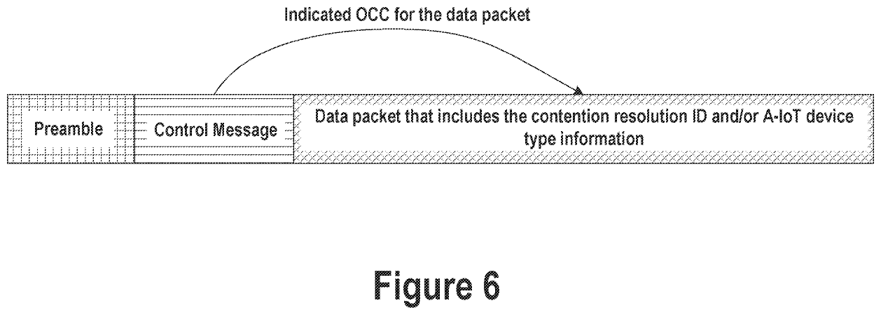

FIG. 6 illustrates one example of OCC for the transmission of data packet that includes the contention resolution ID. In the example, assuming 4 OCC with length 4, one A-IoT devices selects the first OCC from the 4 OCCs and applies this to the transmission of data packet that includes the contention resolution ID. The selected OCC index is indicated in the control message that is transmitted before the data packet.

In one embodiment, in Element 3, the contention resolution ID for one or more A-IoT devices may be included in the acknowledgment message. In this case, the control message prior to the data packet that contains the received contention resolution IDs may include the number of A-IoT devices or contention resolution IDs.

In some aspects, the message in Element 3 may also include the scheduling information for the transmission of acknowledgement message in Element 4. The scheduling information may also include the scheduling gap between the message in Element 3 and the message in Element 4. In one option, for A-IoT device that can generate UL transmission internally, reader may include the frequency domain resource allocation for the transmission of message in Element 4. In one example, the frequency domain resource allocation may include the physical resource block (PRB) index for the transmission of message in Element 4.

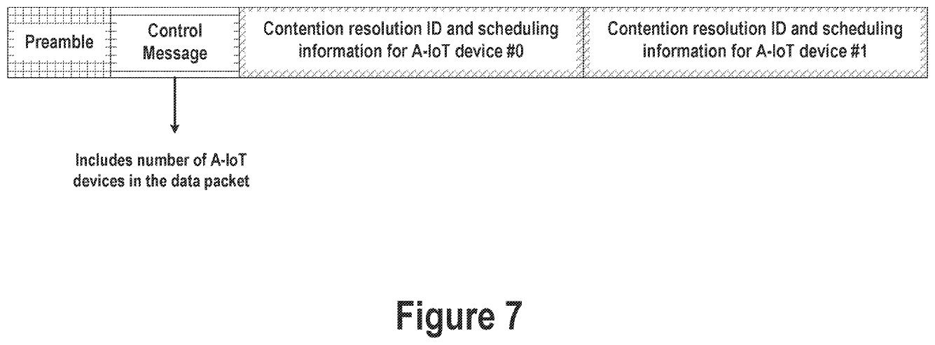

FIG. 7 illustrates one example of message format in Element 3. In particular, in the control message, 2 A-IoT devices are indicated. Further, contention resolution ID and scheduling information of the two A-IoT devices are included in the data packet for Element 3. In some aspects, a cyclic redundancy check (CRC) may also be used after the data packet in Element 3.

In some aspects, the message in Element 3 may also include the request of A-IoT device capabilities. In this case, when the A-IoT device receives the message in Element 3, the A-IoT device may send the A-IoT device capability information to the reader.

In one embodiment, in Element 4, if the A-IoT device does not receive the message in Element 3, the CRC of the received message in Element 3 is not correct, or the received contention resolution ID does not match the contention resolution ID that is sent in Element 2, after a time period, the A-IoT device may start to monitor or detect the query message in Element 1 and restart the random access procedure.

Further, if the A-IoT device receives the message in Element 3 or the received contention resolution ID matches the contention resolution ID that is sent in Element 2, the A-IoT device sends acknowledgement message in the Element 4 in accordance with the scheduling information that is indicated in the Element 3. If the reader indicates the request of A-IoT device capability, the A-IoT device may transmit the A-IoT device capability in the message in Element 4.

In some aspects, after the reader transmits the query command message in Element 1, the A-IoT devices may expect that the carrier wave signal is transmitted during the random access procedure. This may apply for at least for the A-IoT devices that perform backscattering on the uplink transmission. The carrier wave signal may be transmitted by the gNB or a separate node in the UL spectrum.

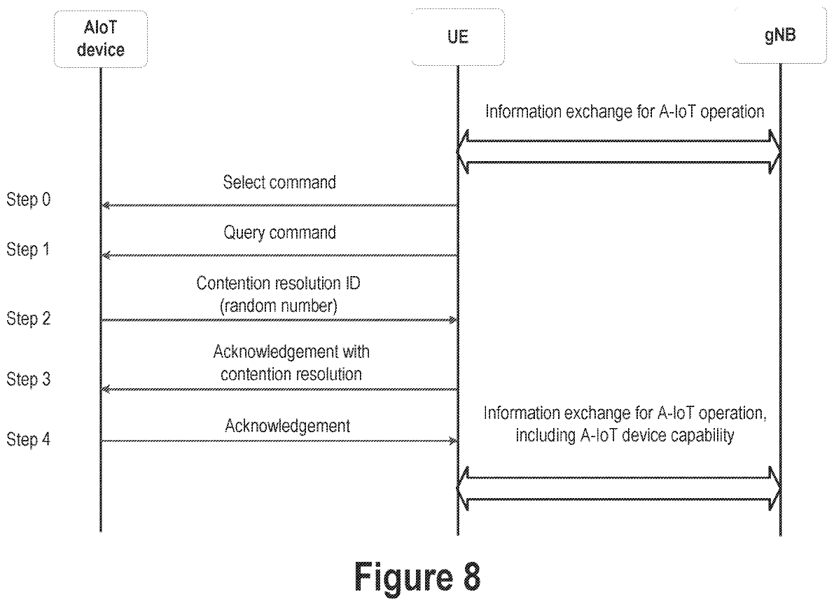

In one embodiment, for Topology 2 for A-IoT applications, where A-IoT device communicates bidirectionally with an intermediate node between the device and base station. and the intermediate node transfers A-IoT data and/or signalling between BS and the A-IoT device, FIG. 8 illustrates one example of random access procedure for A-IoT with topology 2 when intermediate node is the UE.

In the figure, the random access procedure between A-IoT and UE follows the same procedure as that between A-IoT and reader for Topology 1. In addition, before the UE initiates the random access procedure, the gNB may exchange the information on the A-IoT operation. Further, after the random access procedure is complete, the UE may send the A-IoT capability information to the gNB.

### A-IoT Physical Channel

In new radio (NR), uplink (UL) and downlink (DL) physical channels and signals may be designed based on cyclic prefix-orthogonal frequency-division multiplexing (CP-OFDM) waveforms for DL and/or UL, and additionally, Discrete Fourier Transform-spread-OFDM (DFT-s-OFDM) waveforms for UL. However, for A-IoT devices with extremely low power consumption, waveforms, i.e., on off keying (OOK), amplitude shift keying (ASK), etc, may be applied for physical channels and/or signals for A-IoT applications. In this case, certain designs may need to be considered for the physical channel and signal structures for A-IoT applications.

Embodiments herein may relate to physical channel and signal structure for A-IOT applications. In particular, embodiments may relate to or include one or more of the following:
Time domain resource for physical channel and signal for A-IoT
Physical channel and signal structure for A-IOT

### Time Domain Resource for Physical Channel and Signal for A-IoT

As mentioned above, In NR, uplink (UL) and downlink (DL) physical channels and signals may be based on cyclic prefix-orthogonal frequency-division multiplexing (CP-OFDM) waveform for DL and/or UL, and additionally or alternatively, Discrete Fourier Transform-spread-OFDM (DFT-s-OFDM) waveform for UL. However, for A-IoT devices with extremely low power consumption, waveforms, i.e., on off keying (OOK), amplitude shift keying (ASK), etc, may be applied for physical channels and/or signals for A-IoT applications. In this case, one or more of the following designs may be considered for the physical channel and signal structures for A-IoT applications.

Example embodiments of time domain resource for physical channel and signal for A-IoT are provided as follows:

In one embodiment, an orthogonal frequency division multiplexing (OFDM) symbol in NR (e.g., a DL OFDM symbol) may be equally divided to N symbols or chips for a physical channel and/or signal for A-IoT. In some embodiments, these N symbols may be referred to as “A-IoT” symbols. Transmission of such A-IoT symbols may be referred to as an “A-IoT” transmission. In embodiments, the A-IoT transmission may be from an A-IoT device to a reader (e.g., a base station or a UE). This type of transmission may be referred to as device-to-reader, or “D2R” transmission. In embodiments, the A-IoT transmission may be from a reader (e.g., a base station or a UE) to an A-IoT device. This type of transmission may be referred to as reader-to-device, or “R2D” transmission. By contrast, transmissions of cellular signals between two devices such as a UE and a base station may be referred to herein as “cellular transmissions.” It will be understood that such terms are used for the sake of discussion, and are not intended to provide other limitations to such symbols or transmissions.

In addition, the boundary of an OFDM symbol may be aligned with the boundary of symbol or chip for a physical channel and/or signal for A-IoT (e.g., the timing of the A-IoT channel or signal may be based on the timing of the DL OFDM). In some aspects, N may be predefined in a corresponding 3GPP specification, and may be determined in accordance with the subcarrier spacing used in the NR system. In one example, N may be predefined as 16.

In some aspects, if more than one N values are defined for A-IoT, the indication of N values may be included in the triggering or broadcast command from a base station (e.g., a gNodeB (gNB)) and/or intermediate node. In another option, N value may be determined implicitly in accordance with the subcarrier spacing for the NR system.

In one option, the determination of the symbol or chip duration for A-IoT from OFDM symbol in NR may exclude the cyclic prefix (CP) duration. In this case, the CP duration may not be used for physical channel and/or signal for A-IoT applications. In another option, the first part of a first symbol for the physical channel and/or signal after CP duration is copied to create the CP. In another option, the last part of first symbol for the physical channel and/or signal after CP duration is copied to create the CP.

In another option, the determination of the symbol or chip duration for A-IoT from OFDM symbol in NR may include the cyclic prefix (CP) duration. In some aspects, this CP duration may not include the longer 0.5 microsecond (us) at the beginning of every 0.5 milliseconds (ms) as defined in NR-related 3GPP specifications.

Further, in one option, OFDM symbol duration and slot duration may be defined in accordance with the subcarrier spacing which may be predefined in the specifications or configured by higher layers via NR remaining minimum system information (RMSI), NR other system information (OSI) or dedicated radio resource control (RRC) signalling. This may apply for the case when UE is used as immediate node for Topology 2.

In another option, for A-IoT devices, OFDM symbol duration and slot duration may be defined in accordance with the subcarrier spacing which may be predefined in the specifications or indicated in the triggering or broadcast command from either gNB or intermediate node.

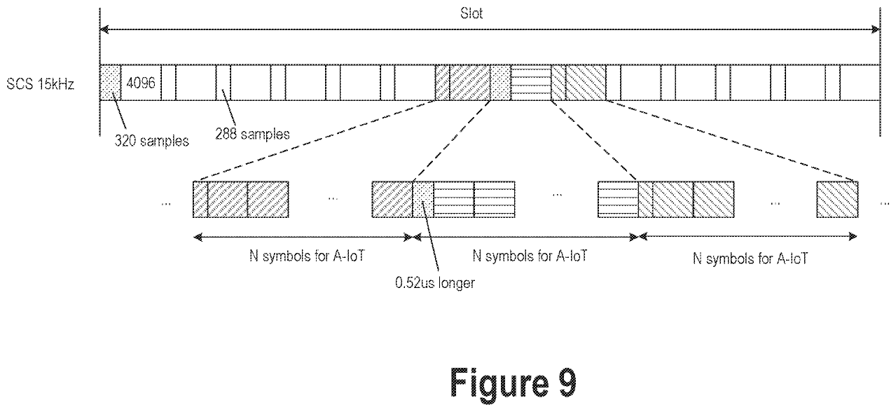

FIG. 9 illustrates one example of symbol or chip duration for physical channel and signal for A-IoT. In the example, OFDM symbol duration excluding CP is equally divided into N symbols for A-IoT.

In another embodiment, in NR, a longer CP with 0.52 microseconds (us) longer duration is defined in every 0.5 milliseconds (ms). In one option, physical channel and/or signal for A-IoT may not be transmitted in this 0.52 us duration. In another option, the first part of first symbol for the physical channel and/or signal after 0.52 us is copied to create the longer symbol. In another option, the last part of first symbol for the physical channel and/or signal after 0.52 us is copied to create the longer symbol.

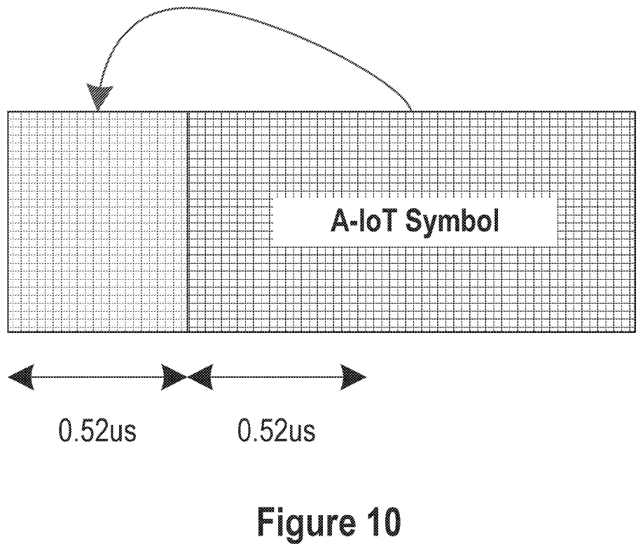

FIG. 10 illustrates one example of handling longer CP duration for A-IoT. In the example, the first part of A-IoT symbol is copied to create the 0.52 us.

In another embodiment, a slot or a subframe in NR may be equally divided into N symbols or chips for a physical channel and/or signal for A-IoT. In addition, the boundary of a slot or subframe may be aligned with the boundary of symbol or chip for a physical channel and/or signal for A-IoT. In some aspects, N may be predefined in the specification, which may be determined in accordance with the subcarrier spacing used in the NR system. In one example, N may be predefined as 64.

In some aspects, if more than one N values are defined for A-IoT, the indication of N values may be included in the triggering or broadcast command from either gNB or intermediate node. In another option, N value may be determined implicitly in accordance with the subcarrier spacing for the NR system.

In one embodiment, starting positioning of a physical channel and/or signal for A-IoT may align with an OFDM symbol boundary, a slot boundary, a subframe boundary, and/or a frame boundary.

In another option, the starting positioning of a physical channel and/or signal for A-IoT may be defined relative to the start of a slot, a subframe, and/or a frame.

In one option, a physical channel and/or signal for A-IT may be confined with a slot or a subframe. In another option, a physical channel and/or signal for A-IoT may span across more than one slot or one subframe.

Further, in one option, OFDM symbol duration and slot duration may be defined in accordance with the subcarrier spacing which is predefined in the specifications or configured by higher layers via NR remaining minimum system information (RMSI), NR other system information (OSI) or dedicated radio resource control (RRC) signalling.

In another option, for A-IoT devices, OFDM symbol duration and slot duration may be defined in accordance with the subcarrier spacing which may be predefined in the specifications or indicated in the triggering or broadcast command from either gNB or intermediate node.

In some aspects, the physical channel or signal may include the carrier wave which is used for backscattering the uplink transmission from A-IoT device.

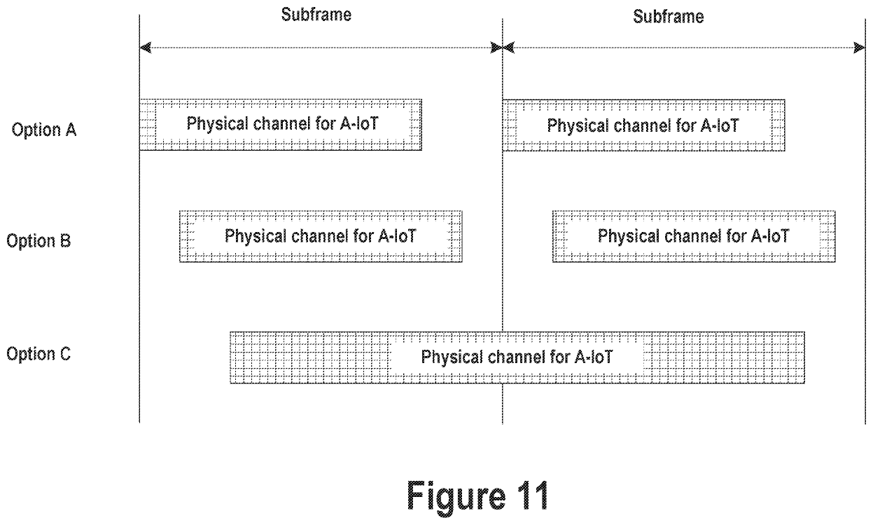

FIG. 11 illustrates examples of time domain resource for physical channel for A-IoT based on subframe. In the examples, the following options are considered:
Option A: the starting positioning of a physical channel is aligned with subframe boundary. In addition, a physical channel is confined within a subframe.
Option B: the starting positioning of a physical channel is aligned with the OFDM waveform boundary, but has offset relative to the subframe boundary. In addition, a physical channel is confined within a subframe.
Option C: the starting positioning of a physical channel is aligned with OFDM symbol or subframe boundary. In addition, a physical channel may span across more than one subframes.

Note that, in some Figures herein such as FIG. 11, the time domain resource for physical channel for A-IoT may be defined in accordance with the subframe. However, it will be recognized that concepts herein may be extended to the case of a time domain resource for physical channel for A-IoT that is defined in accordance with the slot.

In another embodiment, more than one slots or subframes can be grouped as reference for time domain resource for physical channel or signal for A-IoT. In particular, K slots or subframes may be formed as a bundled slot or a bundled subframe as reference, where K can be predefined in the relevant 3GPP specifications, configured by higher layers, or indicated in the triggering or broadcast command from one or both of a BS (e.g., a gNB) and/or an intermediate node. In one example, K may be predefined as 4 or 5.

In one option, the starting positioning of a physical channel and/or signal for A-IoT may align with a bundled slot or a bundled subframe boundary.

In another option, the starting positioning of a physical channel and/or signal for A-IoT may be defined relative to the start of a bundled slot or a bundled subframe.

In one option, a physical channel and/or signal for A-IoT may be confined with a bundled slot or a bundled subframe. In another option, a physical channel and/or signal for A-IoT may span across more than one bundled slot or one bundled subframe.

In some aspects, the physical channel or signal may include the carrier wave which is used for backscattering the uplink transmission from A-IoT device.

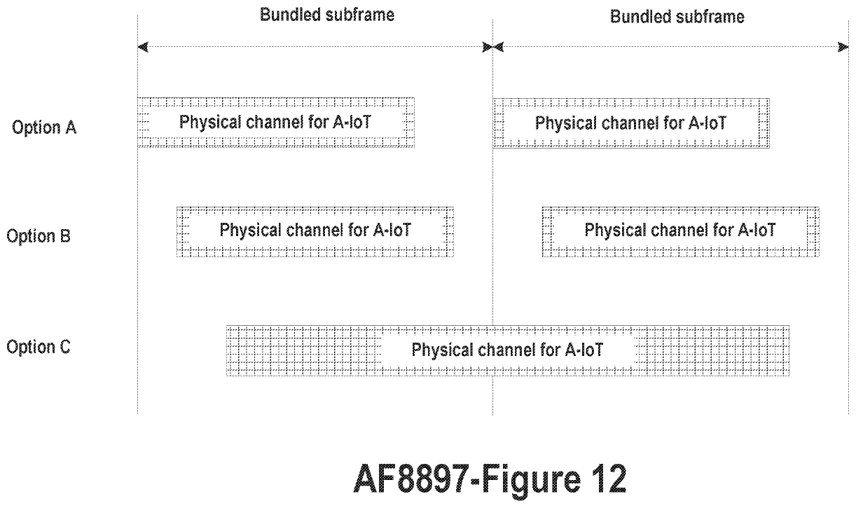

FIG. 12 illustrates examples of a time domain resource for a physical channel for A-IoT, which may be based on a bundled subframe. In the figure, one or more of the following options may be considered:
Option A: the starting positioning of a physical channel is aligned with a bundled subframe boundary. In addition, a physical channel is confined within a bundled subframe.
Option B: the starting positioning of a physical channel is aligned with the OFDM waveform boundary, but has offset relative to the bundled subframe boundary. In addition, a physical channel is confined within a bundled subframe.
Option C: the starting positioning of a physical channel is aligned with OFDM symbol or bundled subframe boundary. In addition, a physical channel may span across more than one bundled subframes.

### Physical Channel and Signal Structure for A-IoT

Embodiments of physical channel and signal structure for A-IoT are provided as follows:

In one embodiment, for A-IoT applications, a physical channel and/or signal may include two parts. In particular, the first part may be defined as preamble, which may be used for presence detection of the second part or for time and/or frequency synchronization. The second part may be used to carry control information and/or data packet for A-IoT applications. Note that the second part may immediately follow the first part in the time domain.

In some aspects, a physical channel and/or signal may only include one part. In one example, a physical channel may only include preamble. In another example, a physical channel may only include control information and/or data packet for A-IoT applications.

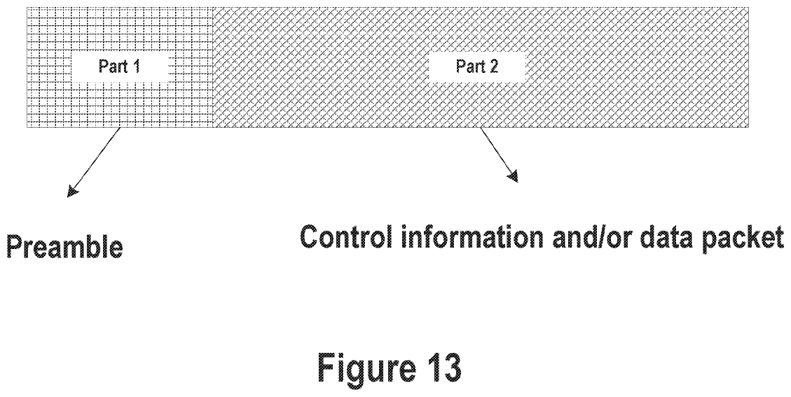

FIG. 13 illustrates one example of physical channel structure with two parts. In the figure, the first part includes the preamble and second part includes control information and/or data packet for A-IoT applications.

In some aspects, this may apply for device to reader (D2R) transmission, including the transmission from A-IoT device to base station in Topology 1 or from A-IoT device to intermediate node in Topology 2 as mentioned above.

In another embodiment, for A-IoT applications, a physical channel and/or signal may include three parts. In particular, the first part may be defined as preamble; the second part may be used to carry control information, which may be used for the scheduling data packet in the third part; the third part may be used to carry data packet.

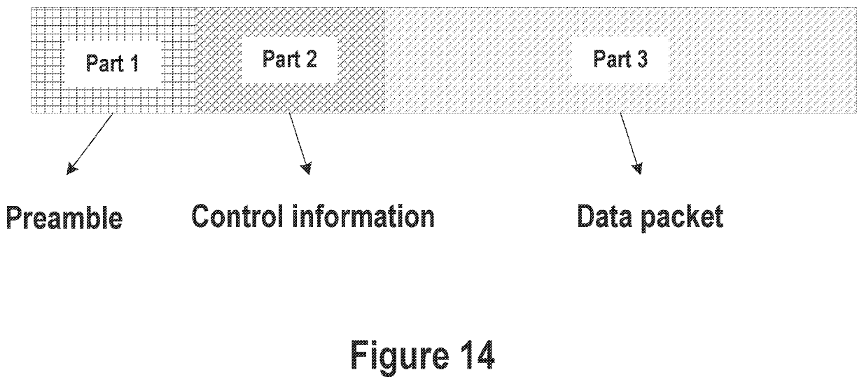

FIG. 14 illustrates one example of physical channel structure with three parts. In the figure, the first part includes the preamble, second part includes control information and third part includes data packet for A-IoT applications.

In some aspects, this may apply for reader to device (R2D) transmission, including the transmission from base station to A-IoT device in Topology 1 or from intermediate node to A-IoT device in Topology 2 as mentioned above.

In another option, for A-IoT applications, a physical channel and/or signal may include three parts. In particular, the first part may be defined as preamble; the second part may be used to carry control information and/or data packet; and the third part may be defined as postamble, which may be used to indicate the termination of the data packet.

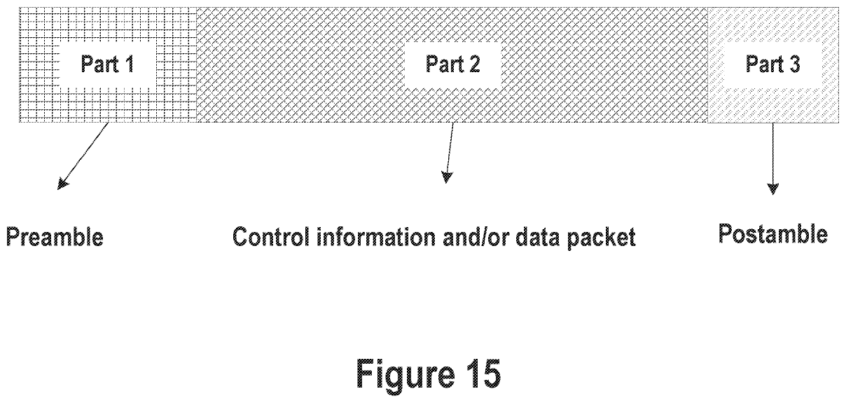

FIG. 15 illustrates one example of physical channel structure with three parts. In the figure, the first part may include the preamble, the second part may include control information or data packet(s) for or related to A-IoT applications; and the third part may include the postamble.

In another embodiment, for A-IoT applications, the preamble and/or postamble may be defined as a physical signal. In addition, the carrier wave which is used for backscattering the uplink transmission from A-IoT device may be defined as a physical signal. In this case, the preamble may be immediately followed by a R2D or D2R physical channel.

### Systems and Implementations

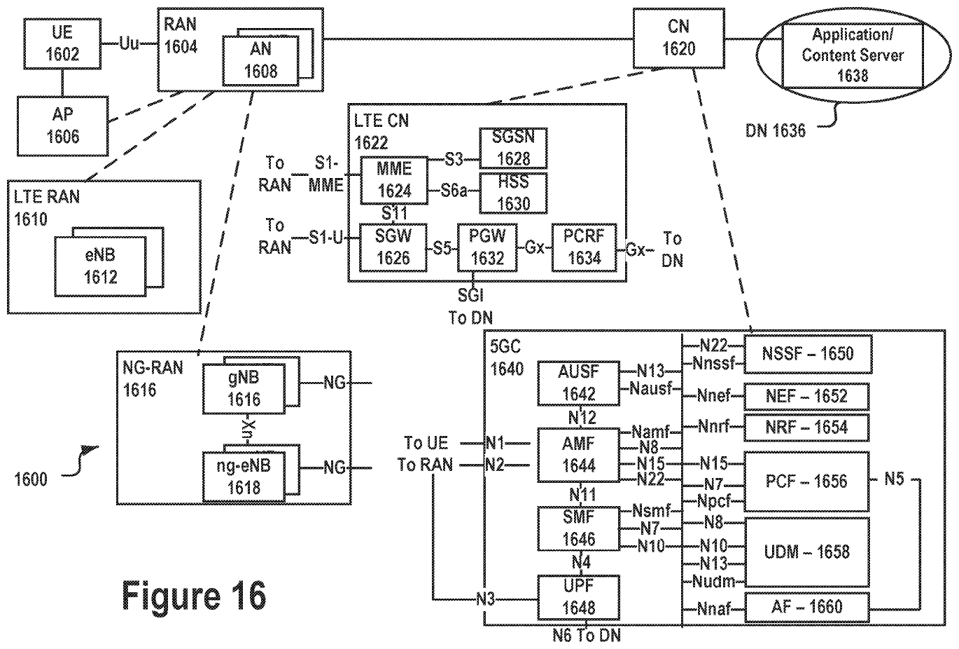

FIGS. 16-19 illustrate various systems, devices, and components that may implement aspects of disclosed embodiments.

FIG. 16 illustrates a network 1600 in accordance with various embodiments. The network 1600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1600 may include a UE 1602, which may include any mobile or non-mobile computing device designed to communicate with a RAN 1604 via an over-the-air connection. The UE 1602 may be communicatively coupled with the RAN 1604 by a Uu interface. The UE 1602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1602 may additionally communicate with an AP 1606 via an over-the-air connection. The AP 1606 may manage a WLAN connection, which may serve to offload some/all network traffic from the RAN 1604. The connection between the UE 1602 and the AP 1606 may be consistent with any IEEE 802.11 protocol, wherein the AP 1606 could be a wireless fidelity (Wi-Fi®) router. In some embodiments, the UE 1602, RAN 1604, and AP 1606 may utilize cellular-WLAN aggregation (for example, LWA/LWIP). Cellular-WLAN aggregation may involve the UE 1602 being configured by the RAN 1604 to utilize both cellular radio resources and WLAN resources.

The RAN 1604 may include one or more access nodes, for example, AN 1608. AN 1608 may terminate air-interface protocols for the UE 1602 by providing access stratum protocols including RRC, PDCP, RLC, MAC, and L1 protocols. In this manner, the AN 1608 may enable data/voice connectivity between CN 1620 and the UE 1602. In some embodiments, the AN 1608 may be implemented in a discrete device or as one or more software entities running on server computers as part of, for example, a virtual network, which may be referred to as a CRAN or virtual baseband unit pool. The AN 1608 be referred to as a BS, gNB, RAN node, eNB, ng-eNB, NodeB, RSU, TRxP, TRP, etc. The AN 1608 may be a macrocell base station or a low power base station for providing femtocells, picocells or other like cells having smaller coverage areas, smaller user capacity, or higher bandwidth compared to macrocells.

In embodiments in which the RAN 1604 includes a plurality of ANs, they may be coupled with one another via an X2 interface (if the RAN 1604 is an LTE RAN) or an Xn interface (if the RAN 1604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1604 may each manage one or more cells, cell groups, component carriers, etc. to provide the UE 1602 with an air interface for network access. The UE 1602 may be simultaneously connected with a plurality of cells provided by the same or different ANs of the RAN 1604. For example, the UE 1602 and RAN 1604 may use carrier aggregation to allow the UE 1602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1602 or AN 1608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1604 may be an LTE RAN 1610 with eNBs, for example, eNB 1612. The LTE RAN 1610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1604 may be an NG-RAN 1614 with gNBs, for example, gNB 1616, or ng-eNBs, for example, ng-eNB 1618. The gNB 1616 may connect with 5G-enabled UEs using a 5G NR interface. The gNB 1616 may connect with a 5G core through an NG interface, which may include an N2 interface or an N3 interface. The ng-eNB 1618 may also connect with the 5G core through an NG interface, but may connect with a UE via an LTE air interface. The gNB 1616 and the ng-eNB 1618 may connect with each other over an Xn interface.

In some embodiments, the NG interface may be split into two parts, an NG user plane (NG-U) interface, which carries traffic data between the nodes of the NG-RAN 1614 and a UPF 1648 (e.g., N3 interface), and an NG control plane (NG-C) interface, which is a signaling interface between the nodes of the NG-RAN 1614 and an AMF 1644 (e.g., N2 interface).

The NG-RAN 1614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1602 can be configured with multiple BWPs where each BWP configuration has a different SCS. When a BWP change is indicated to the UE 1602, the SCS of the transmission is changed as well. Another use case example of BWP is related to power saving. In particular, multiple BWPs can be configured for the UE 1602 with different amount of frequency resources (for example, PRBs) to support data transmission under different traffic loading scenarios. A BWP containing a smaller number of PRBs can be used for data transmission with small traffic load while allowing power saving at the UE 1602 and in some cases at the gNB 1616. A BWP containing a larger number of PRBs can be used for scenarios with higher traffic load.

The RAN 1604 is communicatively coupled to CN 1620 that includes network elements to provide various functions to support data and telecommunications services to customers/subscribers (for example, users of UE 1602). The components of the CN 1620 may be implemented in one physical node or separate physical nodes. In some embodiments, NFV may be utilized to virtualize any or all of the functions provided by the network elements of the CN 1620 onto physical compute/storage resources in servers, switches, etc. A logical instantiation of the CN 1620 may be referred to as a network slice, and a logical instantiation of a portion of the CN 1620 may be referred to as a network sub-slice.

In some embodiments, the CN 1620 may be an LTE CN 1622, which may also be referred to as an EPC. The LTE CN 1622 may include MME 1624, SGW 1626, SGSN 1628, HSS 1630, PGW 1632, and PCRF 1634 coupled with one another over interfaces (or “reference points”) as shown. Functions of the elements of the LTE CN 1622 may be briefly introduced as follows.

The MME 1624 may implement mobility management functions to track a current location of the UE 1602 to facilitate paging, bearer activation/deactivation, handovers, gateway selection, authentication, etc.

The SGW 1626 may terminate an S1 interface toward the RAN and route data packets between the RAN and the LTE CN 1622. The SGW 1626 may be a local mobility anchor point for inter-RAN node handovers and also may provide an anchor for inter-3GPP mobility. Other responsibilities may include lawful intercept, charging, and some policy enforcement.

The SGSN 1628 may track a location of the UE 1602 and perform security functions and access control. In addition, the SGSN 1628 may perform inter-EPC node signaling for mobility between different RAT networks; PDN and S-GW selection as specified by MME 1624; MME selection for handovers; etc. The S3 reference point between the MME 1624 and the SGSN 1628 may enable user and bearer information exchange for inter-3GPP access network mobility in idle/active states.

The HSS 1630 may include a database for network users, including subscription-related information to support the network entities' handling of communication sessions. The HSS 1630 can provide support for routing/roaming, authentication, authorization, naming/addressing resolution, location dependencies, etc. An S6a reference point between the HSS 1630 and the MME 1624 may enable transfer of subscription and authentication data for authenticating/authorizing user access to the LTE CN 1620.

The PGW 1632 may terminate an SGi interface toward a data network (DN) 1636 that may include an application/content server 1638. The PGW 1632 may route data packets between the LTE CN 1622 and the data network 1636. The PGW 1632 may be coupled with the SGW 1626 by an S5 reference point to facilitate user plane tunneling and tunnel management. The PGW 1632 may further include a node for policy enforcement and charging data collection (for example, PCEF). Additionally, the SGi reference point between the PGW 1632 and the data network 1636 may be an operator external public, a private PDN, or an intra-operator packet data network, for example, for provision of IMS services. The PGW 1632 may be coupled with a PCRF 1634 via a Gx reference point.

The PCRF 1634 is the policy and charging control element of the LTE CN 1622. The PCRF 1634 may be communicatively coupled to the app/content server 1638 to determine appropriate QoS and charging parameters for service flows. The PCRF 1632 may provision associated rules into a PCEF (via Gx reference point) with appropriate TFT and QCI.

In some embodiments, the CN 1620 may be a 5GC 1640. The 5GC 1640 may include an AUSF 1642, AMF 1644, SMF 1646, UPF 1648, NSSF 1650, NEF 1652, NRF 1654, PCF 1656, UDM 1658, and AF 1660 coupled with one another over interfaces (or “reference points”) as shown. Functions of the elements of the 5GC 1640 may be briefly introduced as follows.

The AUSF 1642 may store data for authentication of UE 1602 and handle authentication-related functionality. The AUSF 1642 may facilitate a common authentication framework for various access types. In addition to communicating with other elements of the 5GC 1640 over reference points as shown, the AUSF 1642 may exhibit an Nausf service-based interface.

The AMF 1644 may allow other functions of the 5GC 1640 to communicate with the UE 1602 and the RAN 1604 and to subscribe to notifications about mobility events with respect to the UE 1602. The AMF 1644 may be responsible for registration management (for example, for registering UE 1602), connection management, reachability management, mobility management, lawful interception of AMF-related events, and access authentication and authorization. The AMF 1644 may provide transport for SM messages between the UE 1602 and the SMF 1646, and act as a transparent proxy for routing SM messages. AMF 1644 may also provide transport for SMS messages between UE 1602 and an SMSF. AMF 1644 may interact with the AUSF 1642 and the UE 1602 to perform various security anchor and context management functions. Furthermore, AMF 1644 may be a termination point of a RAN CP interface, which may include or be an N2 reference point between the RAN 1604 and the AMF 1644; and the AMF 1644 may be a termination point of NAS (N1) signaling, and perform NAS ciphering and integrity protection. AMF 1644 may also support NAS signaling with the UE 1602 over an N3 IWF interface.

The SMF 1646 may be responsible for SM (for example, session establishment, tunnel management between UPF 1648 and AN 1608); UE IP address allocation and management (including optional authorization); selection and control of UP function; configuring traffic steering at UPF 1648 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1644 over N2 to AN 1608; and determining SSC mode of a session. SM may refer to management of a PDU session, and a PDU session or “session” may refer to a PDU connectivity service that provides or enables the exchange of PDUs between the UE 1602 and the data network 1636.

The UPF 1648 may act as an anchor point for intra-RAT and inter-RAT mobility, an external PDU session point of interconnect to data network 1636, and a branching point to support multi-homed PDU session. The UPF 1648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1648 may include an uplink classifier to support routing traffic flows to a data network.

The NSSF 1650 may select a set of network slice instances serving the UE 1602. The NSSF 1650 may also determine allowed NSSAI and the mapping to the subscribed S-NSSAIs, if needed. The NSSF 1650 may also determine the AMF set to be used to serve the UE 1602, or a list of candidate AMFs based on a suitable configuration and possibly by querying the NRF 1654. The selection of a set of network slice instances for the UE 1602 may be triggered by the AMF 1644 with which the UE 1602 is registered by interacting with the NSSF 1650, which may lead to a change of AMF. The NSSF 1650 may interact with the AMF 1644 via an N22 reference point; and may communicate with another NSSF in a visited network via an N31 reference point (not shown). Additionally, the NSSF 1650 may exhibit an Nnssf service-based interface.

The NEF 1652 may securely expose services and capabilities provided by 3GPP network functions for third party, internal exposure/re-exposure, AFs (e.g., AF 1660), edge computing or fog computing systems, etc. In such embodiments, the NEF 1652 may authenticate, authorize, or throttle the AFs. NEF 1652 may also translate information exchanged with the AF 1660 and information exchanged with internal network functions. For example, the NEF 1652 may translate between an AF-Service-Identifier and an internal 5GC information. NEF 1652 may also receive information from other NFs based on exposed capabilities of other NFs. This information may be stored at the NEF 1652 as structured data, or at a data storage NF using standardized interfaces. The stored information can then be re-exposed by the NEF 1652 to other NFs and AFs, or used for other purposes such as analytics. Additionally, the NEF 1652 may exhibit an Nnef service-based interface.

The NRF 1654 may support service discovery functions, receive NF discovery requests from NF instances, and provide the information of the discovered NF instances to the NF instances. NRF 1654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1654 may exhibit the Nnrf service-based interface.

The PCF 1656 may provide policy rules to control plane functions to enforce them, and may also support unified policy framework to govern network behavior. The PCF 1656 may also implement a front end to access subscription information relevant for policy decisions in a UDR of the UDM 1658. In addition to communicating with functions over reference points as shown, the PCF 1656 exhibit an Npcf service-based interface.

The UDM 1658 may handle subscription-related information to support the network entities' handling of communication sessions, and may store subscription data of UE 1602. For example, subscription data may be communicated via an N8 reference point between the UDM 1658 and the AMF 1644. The UDM 1658 may include two parts, an application front end and a UDR. The UDR may store subscription data and policy data for the UDM 1658 and the PCF 1656, and/or structured data for exposure and application data (including PFDs for application detection, application request information for multiple UEs 1602) for the NEF 1652. The Nudr service-based interface may be exhibited by the UDR 221 to allow the UDM 1658, PCF 1656, and NEF 1652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1658 may exhibit the Nudm service-based interface.

The AF 1660 may provide application influence on traffic routing, provide access to NEF, and interact with the policy framework for policy control.

In some embodiments, the 5GC 1640 may enable edge computing by selecting operator/3^{rd} party services to be geographically close to a point that the UE 1602 is attached to the network. This may reduce latency and load on the network. To provide edge-computing implementations, the 5GC 1640 may select a UPF 1648 close to the UE 1602 and execute traffic steering from the UPF 1648 to data network 1636 via the N6 interface. This may be based on the UE subscription data, UE location, and information provided by the AF 1660. In this way, the AF 1660 may influence UPF (re)selection and traffic routing. Based on operator deployment, when AF 1660 is considered to be a trusted entity, the network operator may permit AF 1660 to interact directly with relevant NFs. Additionally, the AF 1660 may exhibit an Naf service-based interface.

The data network 1636 may represent various network operator services, Internet access, or third party services that may be provided by one or more servers including, for example, application/content server 1638.

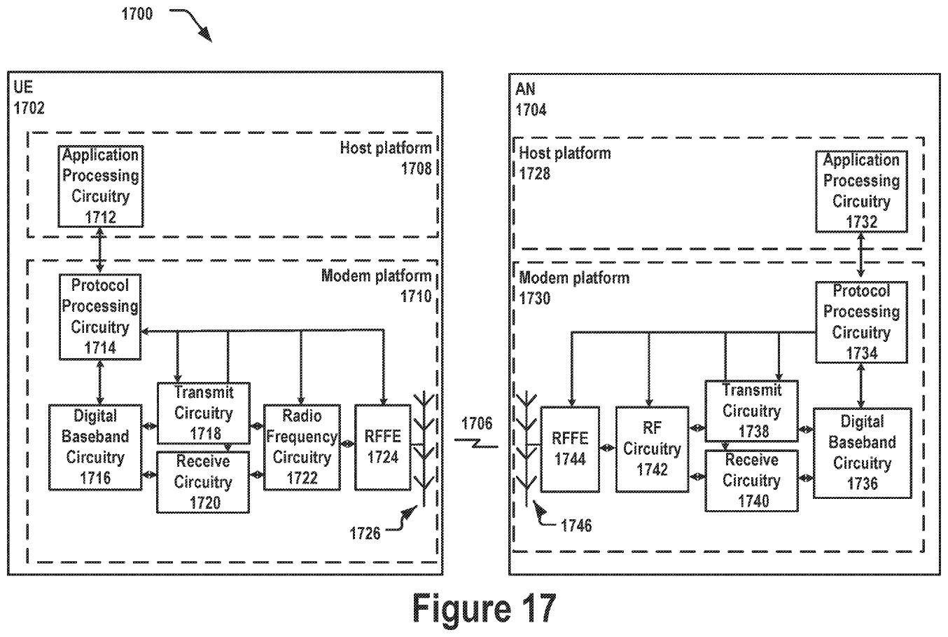

FIG. 17 schematically illustrates a wireless network 1700 in accordance with various embodiments. The wireless network 1700 may include a UE 1702 in wireless communication with an AN 1704. The UE 1702 and AN 1704 may be similar to, and substantially interchangeable with, like-named components described elsewhere herein.

The UE 1702 may be communicatively coupled with the AN 1704 via connection 1706. The connection 1706 is illustrated as an air interface to enable communicative coupling, and can be consistent with cellular communications protocols such as an LTE protocol or a 5G NR protocol operating at mmWave or sub-6GHZ frequencies.

The UE 1702 may include a host platform 1708 coupled with a modem platform 1710. The host platform 1708 may include application processing circuitry 1712, which may be coupled with protocol processing circuitry 1714 of the modem platform 1710. The application processing circuitry 1712 may run various applications for the UE 1702 that source/sink application data. The application processing circuitry 1712 may further implement one or more layer operations to transmit/receive application data to/from a data network. These layer operations may include transport (for example UDP) and Internet (for example, IP) operations

The protocol processing circuitry 1714 may implement one or more of layer operations to facilitate transmission or reception of data over the connection 1706. The layer operations implemented by the protocol processing circuitry 1714 may include, for example, MAC, RLC, PDCP, RRC and NAS operations.

The modem platform 1710 may further include digital baseband circuitry 1716 that may implement one or more layer operations that are “below” layer operations performed by the protocol processing circuitry 1714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1710 may further include transmit circuitry 1718, receive circuitry 1720, RF circuitry 1722, and RF front end (RFFE) 1724, which may include or connect to one or more antenna panels 1726. Briefly, the transmit circuitry 1718 may include a digital-to-analog converter, mixer, intermediate frequency (IF) components, etc. ; the receive circuitry 1720 may include an analog-to-digital converter, mixer, IF components, etc. ; the RF circuitry 1722 may include a low-noise amplifier, a power amplifier, power tracking components, etc.; RFFE 1724 may include filters (for example, surface/bulk acoustic wave filters), switches, antenna tuners, beamforming components (for example, phase-array antenna components), etc. The selection and arrangement of the components of the transmit circuitry 1718, receive circuitry 1720, RF circuitry 1722, RFFE 1724, and antenna panels 1726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1714 may include one or more instances of control circuitry (not shown) to provide control functions for the transmit/receive components.

A UE reception may be established by and via the antenna panels 1726, RFFE 1724, RF circuitry 1722, receive circuitry 1720, digital baseband circuitry 1716, and protocol processing circuitry 1714. In some embodiments, the antenna panels 1726 may receive a transmission from the AN 1704 by receive-beamforming signals received by a plurality of antennas/antenna elements of the one or more antenna panels 1726.

A UE transmission may be established by and via the protocol processing circuitry 1714, digital baseband circuitry 1716, transmit circuitry 1718, RF circuitry 1722, RFFE 1724, and antenna panels 1726. In some embodiments, the transmit components of the UE 1704 may apply a spatial filter to the data to be transmitted to form a transmit beam emitted by the antenna elements of the antenna panels 1726.

Similar to the UE 1702, the AN 1704 may include a host platform 1728 coupled with a modem platform 1730. The host platform 1728 may include application processing circuitry 1732 coupled with protocol processing circuitry 1734 of the modem platform 1730. The modem platform may further include digital baseband circuitry 1736, transmit circuitry 1738, receive circuitry 1740, RF circuitry 1742, RFFE circuitry 1744, and antenna panels 1746. The components of the AN 1704 may be similar to and substantially interchangeable with like-named components of the UE 1702. In addition to performing data transmission/reception as described above, the components of the AN 1708 may perform various logical functions that include, for example, RNC functions such as radio bearer management, uplink and downlink dynamic radio resource management, and data packet scheduling.

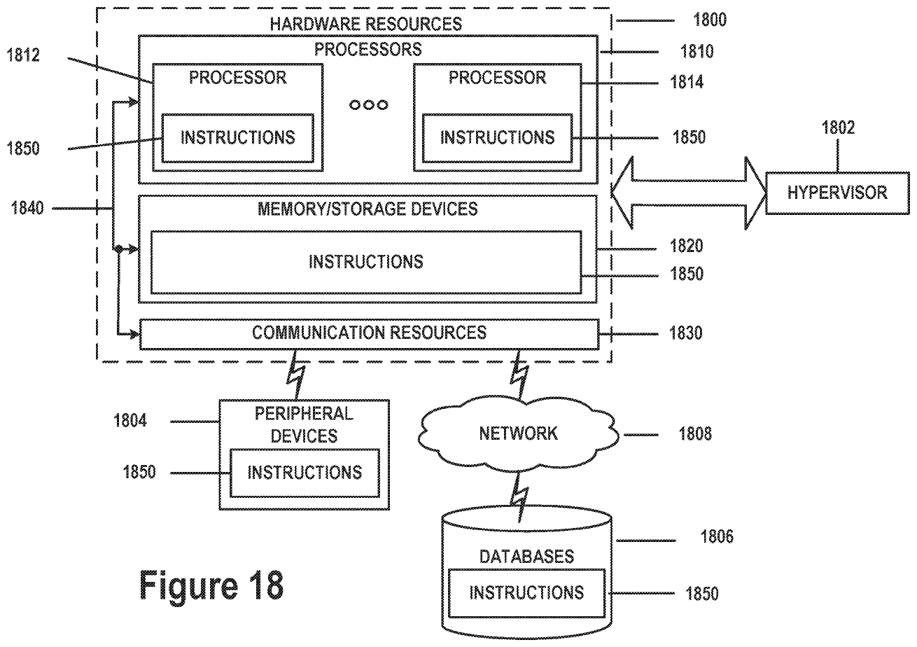

FIG. 18 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 18 shows a diagrammatic representation of hardware resources 1800 including one or more processors (or processor cores) 1810, one or more memory/storage devices 1820, and one or more communication resources 1830, each of which may be communicatively coupled via a bus 1840 or other interface circuitry. For embodiments where node virtualization (e.g., NFV) is utilized, a hypervisor 1802 may be executed to provide an execution environment for one or more network slices/sub-slices to utilize the hardware resources 1800.

The processors 1810 may include, for example, a processor 1812 and a processor 1814. The processors 1810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1820 may include main memory, disk storage, or any suitable combination thereof. The memory/storage devices 1820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1830 may include interconnection or network interface controllers, components, or other suitable devices to communicate with one or more peripheral devices 1804 or one or more databases 1806 or other network elements via a network 1808. For example, the communication resources 1830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1850 may comprise software, a program, an application, an applet, an app, or other executable code for causing at least any of the processors 1810 to perform any one or more of the methodologies discussed herein. The instructions 1850 may reside, completely or partially, within at least one of the processors 1810 (e.g., within the processor's cache memory), the memory/storage devices 1820, or any suitable combination thereof. Furthermore, any portion of the instructions 1850 may be transferred to the hardware resources 1800 from any combination of the peripheral devices 1804 or the databases 1806. Accordingly, the memory of processors 1810, the memory/storage devices 1820, the peripheral devices 1804, and the databases 1806 are examples of computer-readable and machine-readable media.

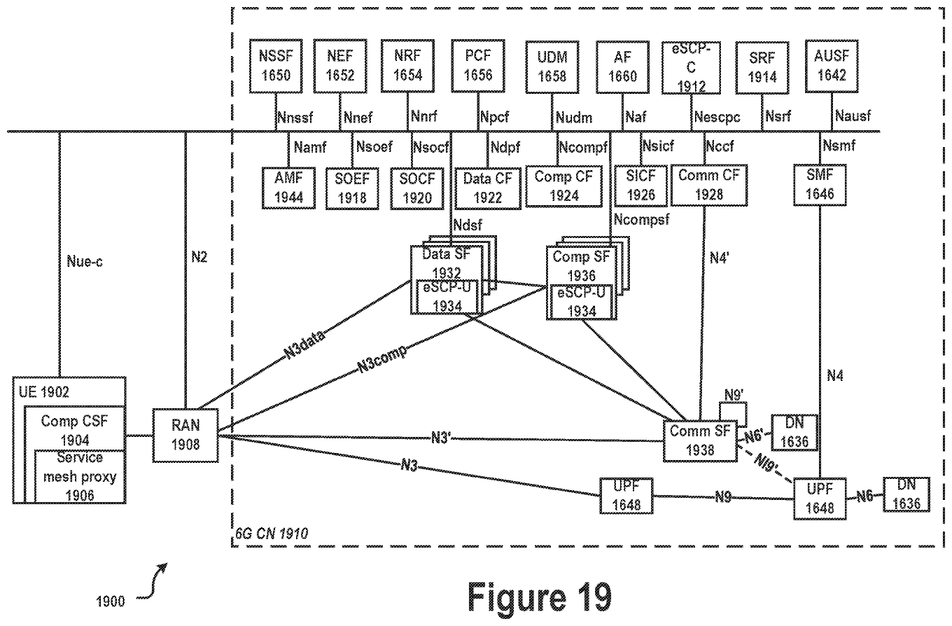

FIG. 19 illustrates a network 1900 in accordance with various embodiments. The network 1900 may operate in a matter consistent with 3GPP technical specifications or technical reports for 6G systems. In some embodiments, the network 1900 may operate concurrently with network 1600. For example, in some embodiments, the network 1900 may share one or more frequency or bandwidth resources with network 1600. As one specific example, a UE (e.g., UE 1902) may be configured to operate in both network 1900 and network 1600. Such configuration may be based on a UE including circuitry configured for communication with frequency and bandwidth resources of both networks 1600 and 1900. In general, several elements of network 1900 may share one or more characteristics with elements of network 1600. For the sake of brevity and clarity, such elements may not be repeated in the description of network 1900.

The network 1900 may include a UE 1902, which may include any mobile or non-mobile computing device designed to communicate with a RAN 1908 via an over-the-air connection. The UE 1902 may be similar to, for example, UE 1602. The UE 1902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 19, in some embodiments the network 1900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 19, the UE 1902 may be communicatively coupled with an AP such as AP 1606 as described with respect to FIG. 16. Additionally, although not specifically shown in FIG. 19, in some embodiments the RAN 1908 may include one or more ANss such as AN 1608 as described with respect to FIG. 16. The RAN 1908 and/or the AN of the RAN 1908 may be referred to as a base station (BS), a RAN node, or using some other term or name.

The UE 1902 and the RAN 1908 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1908 may allow for communication between the UE 1902 and a 6G core network (CN) 1910. Specifically, the RAN 1908 may facilitate the transmission and reception of data between the UE 1902 and the 6G CN 1910. The 6G CN 1910 may include various functions such as NSSF 1650, NEF 1652, NRF 1654, PCF 1656, UDM 1658, AF 1660, SMF 1646, and AUSF 1642. The 6G CN 1910 may additional include UPF 1648 and DN 1636 as shown in FIG. 19.

Additionally, the RAN 1908 may include various additional functions that are in addition to, or alternative to, functions of a legacy cellular network such as a 4G or 5G network. Two such functions may include a Compute Control Function (Comp CF) 1924 and a Compute Service Function (Comp SF) 1936. The Comp CF 1924 and the Comp SF 1936 may be parts or functions of the Computing Service Plane. Comp CF 1924 may be a control plane function that provides functionalities such as management of the Comp SF 1936, computing task context generation and management (e.g., create, read, modify, delete), interaction with the underlying computing infrastructure for computing resource management, etc. Comp SF 1936 may be a user plane function that serves as the gateway to interface computing service users (such as UE 1902) and computing nodes behind a Comp SF instance. Some functionalities of the Comp SF 1936 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1936 instance may serve as the user plane gateway for a cluster of computing nodes. A Comp CF 1924 instance may control one or more Comp SF 1936 instances.

Two other such functions may include a Communication Control Function (Comm CF) 1928 and a Communication Service Function (Comm SF) 1938, which may be parts of the Communication Service Plane. The Comm CF 1928 may be the control plane function for managing the Comm SF 1938, communication sessions creation/configuration/releasing, and managing communication session context. The Comm SF 1938 may be a user plane function for data transport. Comm CF 1928 and Comm SF 1938 may be considered as upgrades of SMF 1646 and UPF 1648, which were described with respect to a 5G system in FIG. 16. The upgrades provided by the Comm CF 1928 and the Comm SF 1938 may enable service-aware transport. For legacy (e.g., 4G or 5G) data transport, SMF 1646 and UPF 1648 may still be used.

Two other such functions may include a Data Control Function (Data CF) 1922 and Data Service Function (Data SF) 1932 may be parts of the Data Service Plane. Data CF 1922 may be a control plane function and provides functionalities such as Data SF 1932 management, Data service creation/configuration/releasing, Data service context management, etc. Data SF 1932 may be a user plane function and serve as the gateway between data service users (such as UE 1902 and the various functions of the 6G CN 1910) and data service endpoints behind the gateway. Specific functionalities may include include: parse data service user data and forward to corresponding data service endpoints, generate charging data, report data service status.

Another such function may be the Service Orchestration and Chaining Function (SOCF) 1920, which may discover, orchestrate and chain up communication/computing/data services provided by functions in the network. Upon receiving service requests from users, SOCF 1920 may interact with one or more of Comp CF 1924, Comm CF 1928, and Data CF 1922 to identify Comp SF 1936, Comm SF 1938, and Data SF 1932 instances, configure service resources, and generate the service chain, which could contain multiple Comp SF 1936, Comm SF 1938, and Data SF 1932 instances and their associated computing endpoints. Workload processing and data movement may then be conducted within the generated service chain. The SOCF 1920 may also responsible for maintaining, updating, and releasing a created service chain.

Another such function may be the service registration function (SRF) 1914, which may act as a registry for system services provided in the user plane such as services provided by service endpoints behind Comp SF 1936 and Data SF 1932 gateways and services provided by the UE 1902. The SRF 1914 may be considered a counterpart of NRF 1654, which may act as the registry for network functions.

Other such functions may include an evolved service communication proxy (eSCP) and service infrastructure control function (SICF) 1926, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1912 and eSCP-U 1934, for control plane service communication proxy and user plane service communication proxy, respectively. The SICF 1926 may control and configure eCSP instances in terms of service traffic routing policies, access rules, load balancing configurations, performance monitoring, etc.

Another such function is the AMF 1944. The AMF 1944 may be similar to 1644, but with additional functionality. Specifically, the AMF 1944 may include potential functional repartition, such as move the message forwarding functionality from the AMF 1944 to the RAN 1908.

Another such function is the service orchestration exposure function (SOEF) 1918. The SOEF may be configured to expose service orchestration and chaining services to external users such as applications.

The UE 1902 may include an additional function that is referred to as a computing client service function (comp CSF) 1904. The comp CSF 1904 may have both the control plane functionalities and user plane functionalities, and may interact with corresponding network side functions such as SOCF 1920, Comp CF 1924, Comp SF 1936, Data CF 1922, and/or Data SF 1932 for service discovery, request/response, compute task workload exchange, etc. The Comp CSF 1904 may also work with network side functions to decide on whether a computing task should be run on the UE 1902, the RAN 1908, and/or an element of the 6G CN 1910.

The UE 1902 and/or the Comp CSF 1904 may include a service mesh proxy 1906. The service mesh proxy 1906 may act as a proxy for service-to-service communication in the user plane. Capabilities of the service mesh proxy 1906 may include one or more of addressing, security, load balancing, etc.

### EXAMPLE PROCEDURES

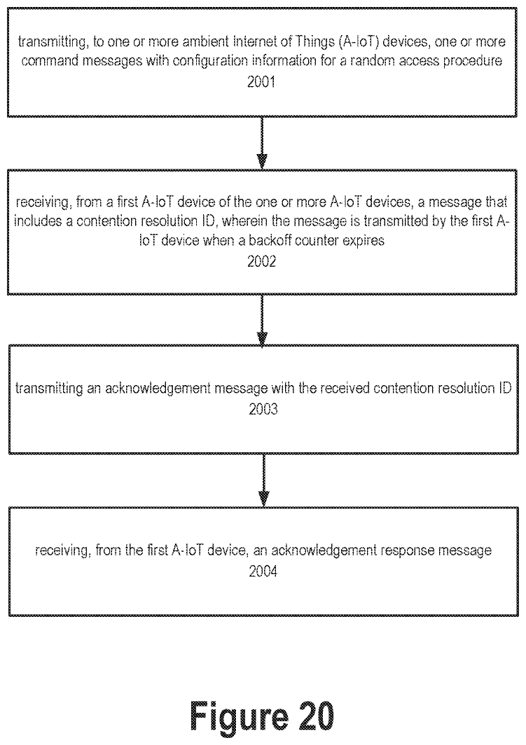

In some embodiments, the electronic device(s), network(s), system(s), chip(s) or component(s), or portions or implementations thereof, of FIGS. 16-19, or some other figure herein, may be configured to perform one or more processes, techniques, or methods as described herein, or portions thereof. One such process is depicted in FIG. 20. In some embodiments, the process of FIG. 20 may be performed by a gNB, a UE, or a portion thereof. At 2001, the process may include transmitting, to one or more ambient Internet of Things (A-IoT) devices, one or more command messages with configuration information for a random access procedure. The one or more command messages may include, for example, a select command and a query command. At 2002, the process may further include receiving, from a first A-IoT device of the one or more A-IoT devices, a message that includes a contention resolution ID, wherein the message is transmitted by the first A-IoT device when a backoff counter expires. At 2003, the process may further include transmitting an acknowledgement message with the received contention resolution ID. At 2004, the process may further include receiving, from the first A-IoT device, an acknowledgement response message.

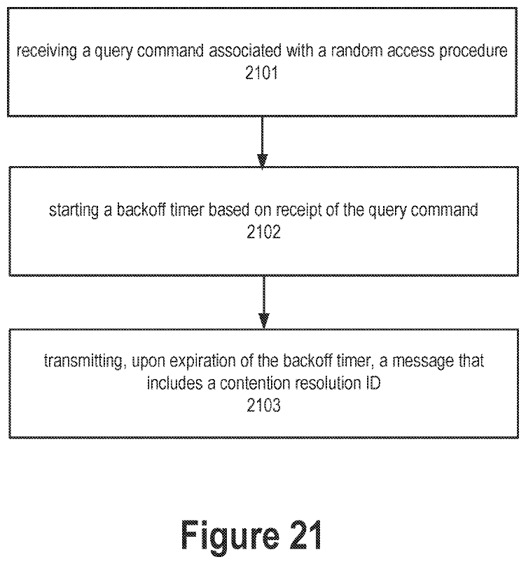

FIG. 21 illustrates another example process in accordance with various embodiments. The process of FIG. 21 may be performed by an Ambient Internet of Things (A-IoT) device or a portion thereof. At 2101, the method may include receiving a query command associated with a random access procedure. At 2102, the method may further include starting a backoff timer based on receipt of the query command. At 2103, the method may further include transmitting, upon expiration of the backoff timer, a message that includes a contention resolution ID.

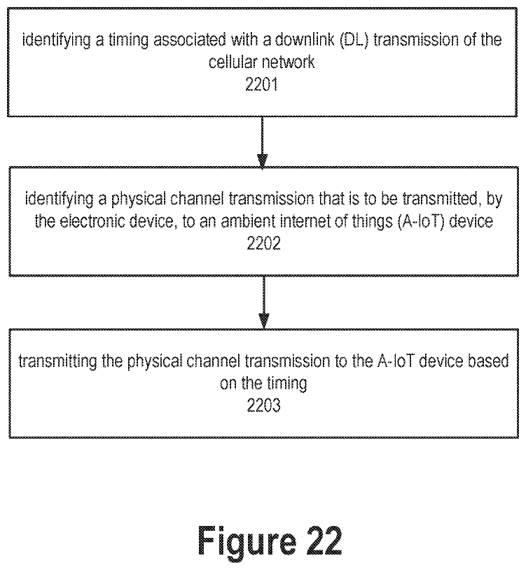

Another such process is depicted in FIG. 22. For example, the process may include or relate to a method to be performed by an electronic device associated with a cellular network. For example, the electronic device may be, implement, and/or include one or more of a base station, a UE, an IAB node, etc. The method may include: identifying, at 2201, a timing associated with a downlink (DL) transmission of the cellular network; identifying, at 2202, a physical channel transmission that is to be transmitted, by the electronic device, to an ambient internet of things (A-IoT) device; and transmitting, at 2203, the physical channel transmission to the A-IoT device based on the timing.

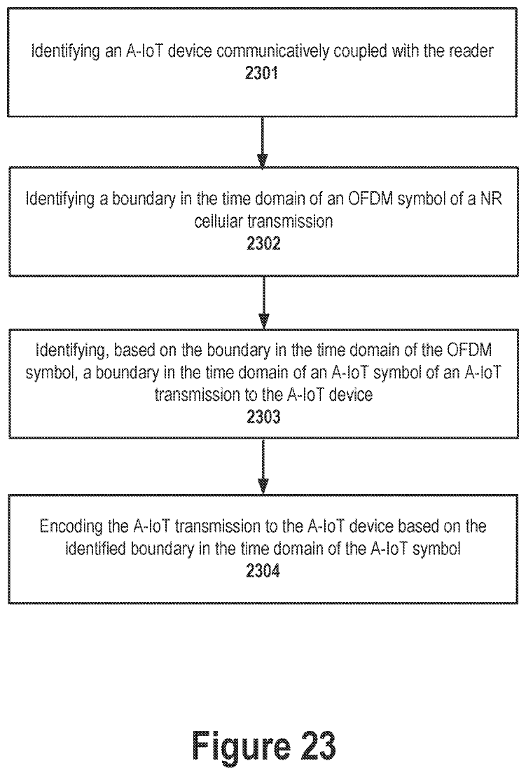

Another such process is depicted in FIG. 23. The process of FIG. 23 may include or relate to a method to be performed by a reader of a cellular network, one or more elements of a reader, and/or one or more electronic devices that include and/or implement the reader. In some embodiments the reader may be a UE. In some embodiments, the reader may be a base station. The process may include: identifying, at 2301, an ambient internet of things (A-IoT) device communicatively coupled with the reader; identifying, at 2302, a boundary in the time domain of an orthogonal frequency division multiplexed (OFDM) symbol of a new radio (NR) cellular transmission; identifying, at 2303 based on the boundary in the time domain of the OFDM symbol, a boundary in the time domain of an A-IoT symbol of an A-IoT transmission to the A-IoT device; and encoding, at 2304, the A-IoT transmission to the A-IoT device based on the identified boundary in the time domain of the A-IoT symbol.

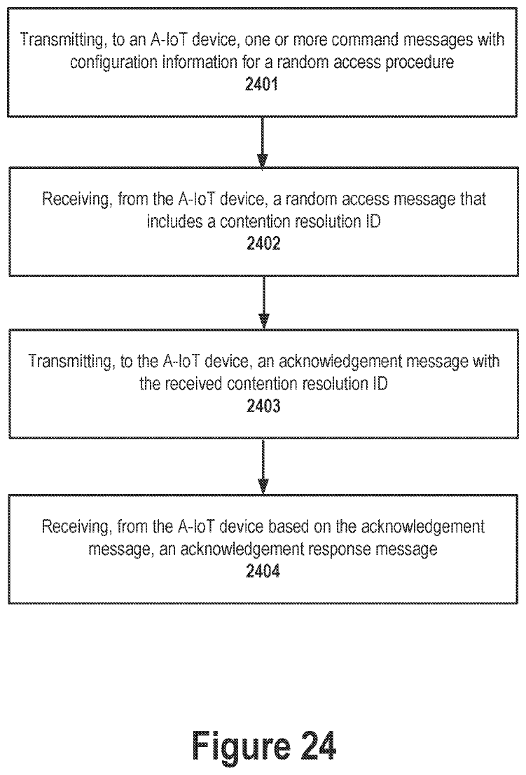

Another such process is depicted in FIG. 24. The process of FIG. 24 may include or relate to a method to be performed by a reader of a cellular network, one or more elements of a reader, and/or one or more electronic devices that include and/or implement the reader. In some embodiments the reader may be a UE. In some embodiments, the reader may be a base station. The process may include: transmitting, at 2401 to an ambient internet of things (A-IoT) device, one or more command messages with configuration information for a random access procedure; receiving, at 2402 from the A-IoT device, a random access message that includes a contention resolution identifier (ID); transmitting, at 2403 to the A-IoT device, an acknowledgement message with the received contention resolution ID; and receiving, at 2404 from the A-IoT device based on the acknowledgement message, an acknowledgement response message.

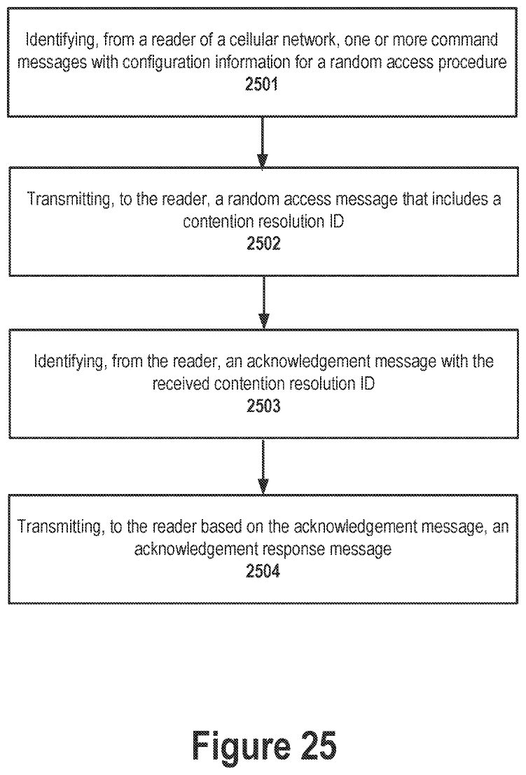

Another such process is depicted in FIG. 25. The process of FIG. 25 may include or relate to a method to be performed by an ambient internet of things (A-IoT) device, one or more elements of an A-IoT device, and/or one or more electronic devices that include and/or implement the A-IoT device. The process may include: identifying, at 2501 from a reader of a cellular network, one or more command messages with configuration information for a random access procedure; transmitting, at 2502 to the reader, a random access message that includes a contention resolution identifier (ID); identifying, at 2503 from the reader, an acknowledgement message with the received contention resolution ID; and transmitting, at 2504 to the reader based on the acknowledgement message, an acknowledgement response message.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include a method comprising:
transmitting, by a gNodeB (gNB) or a UE, a select command message for a set of Ambient Internet of Things (A-IoT) devices,
transmitting, by the gNB or the UE, a query command message for the set of A-IoT devices to perform random access procedure;
receiving, from a A-IoT device, a message that includes a contention resolution ID, wherein the message is transmitted by the A-IoT device when a backoff counter value expires;
transmitting, by the gNB or the UE, an acknowledgement message with the received contention resolution ID; and
receiving, from the A-IoT device, an acknowledgement message when the contention resolution ID matches.

Example 2 may include the method of example 1 and/or one or more other examples herein, wherein after an A-IoT device completes the random access procedure, the A-IoT device may be in a different state; wherein when the gNB or UE performs query for the same set of A-IoT devices, the A-IoT device may not initiate the random access procedure.

Example 3 may include the method of example 1 and/or one or more other examples herein, wherein the query command may be transmitted periodically when activated.

Example 4 may include the method of example 1 and/or one or more other examples herein, wherein when one or more types of A-IoT devices are in the same system, query command may also include an indication on which one of the A-IoT device types may perform the random access procedure.

Example 5 may include the method of example 1 and/or one or more other examples herein, wherein query command may include a backoff indicator or scaling factor for backoff indication.

Example 6 may include the method of example 1 and/or one or more other examples herein, wherein A-IoT device may randomly generate a counter value within a range of [0, K], where K can be determined in accordance with the indicated backoff indication value.

Example 7 may include the method of example 1 and/or one or more other examples herein, wherein randomly generated counter value is decremented by 1 for each unit backoff time passed after the query command or a reference time after the query command.

Example 8 may include the method of example 1 and/or one or more other examples herein, wherein the A-IoT device may include the A-IoT device type and/or A-IoT device capability information in the Step 3 together with contention resolution ID.

Example 9 may include the method of example 1 and/or one or more other examples herein, wherein a set of orthogonal cover codes (OCC) may be defined in the specification, which can be applied to the transmission of the message that contains the contention resolution ID from the A-IoT device.

Example 10 may include the method of example 1 and/or one or more other examples herein, wherein the contention resolution ID for one or more A-IoT devices may be included in the acknowledgment message in Step 3.

Example 11 may include the method of example 1 and/or one or more other examples herein, wherein the message in Step 3 may also include the scheduling information for the transmission of acknowledgement message in Step 4.

Example 12 may include the method of example 1 and/or one or more other examples herein, wherein in Step 4, if the A-IoT device does not receive the message in Step 3, the CRC of the received message in Step 3 is not correct, or the received contention resolution ID does not match the contention resolution ID that is sent in Step 2, after a time period, the A-IoT device may start to monitor or detect the query message in Step 1 and restart the random access procedure.

Example 13 may include the method of example 1 and/or one or more other examples herein, wherein if the A-IoT device receives the message in Step 3 or the received contention resolution ID matches the contention resolution ID that is sent in Step 2, the A-IoT device sends acknowledgement message in the Step 4 in accordance with the scheduling information that is indicated in the Step 3.

Example 14 may include the method of example 1 and/or one or more other examples herein, wherein after the gNB transmits the query command message in Step 1, the A-IoT devices may expect that the carrier wave signal is transmitted during the random access procedure.

Example 15 may include a method comprising:
transmitting, to one or more ambient Internet of Things (A-IoT) devices, one or more command messages with configuration information for a random access procedure;
receiving, from a first A-IoT device of the one or more A-IoT devices, a message that includes a contention resolution ID, wherein the message is transmitted by the first A-IoT device when a backoff counter expires;
transmitting an acknowledgement message with the received contention resolution ID; and
receiving, from the first A-IoT device, an acknowledgement response message.

Example 16 may include the method of example 16 and/or one or more other examples herein, wherein the one or more command messages include a select command and a query command.

Example 17 may include the method of example 15-16 and/or one or more other examples herein, wherein the one or more A-IoT devices include a set of A-IoT devices.

Example 18 may include the method of example 15-17 and/or one or more other examples herein, wherein the acknowledgement message is received from the first A-IoT device if the contention resolution ID in the acknowledgement message matches the contention resolution ID in the message from the first A-IoT device.

Example 19 may include the method of example 16-18 and/or one or more other examples herein, wherein the query command is transmitted periodically.

Example 20 may include the method of example 15-19 and/or one or more other examples herein, wherein the one or more command messages (e.g., the query command) includes an indication of an A-IoT device type that is to perform the random access procedure.

Example 21 may include the method of example 15-20 and/or one or more other examples herein, wherein the one or more command messages (e.g., the query command) indicates a value of the backoff counter and/or includes a scaling factor for the backoff counter.

Example 22 may include the method of example 15-21 and/or one or more other examples herein, wherein a value of the backoff counter is randomly generated.

Example 23 may include the method of example 16-22 and/or one or more other examples herein, wherein the backoff counter is started based on receipt of the query command.

Example 24 may include the method of example 15-23 and/or one or more other examples herein, wherein the message that includes the contention resolution ID further includes an A-IoT device type and/or A-IoT device capability information of the first A-IoT device.

Example 25 may include the method of example 15-24 and/or one or more other examples herein, wherein a set of orthogonal cover codes (OCCs) are applied to the message from the A-IoT device that includes the contention resolution ID.

Example 26 may include the method of example 25 and/or one or more other examples herein, wherein the set of OCCs are predefined.

Example 27 may include the method of example 15-26 and/or one or more other examples herein, wherein the acknowledgement message includes respective contention resolution IDs for multiple A-IoT devices.

Example 28 may include the method of example 15-27 and/or one or more other examples herein, wherein the acknowledgement message further includes scheduling information for the acknowledgement response message.

Example 29 may include the method of example 15-28 and/or one or more other examples herein, wherein the method is performed by a next generation Node B (gNB).

Example 30 may include the method of example 15-28 and/or one or more other examples herein, wherein the method is performed by a user equipment (UE).

Example 31 may include the method of example 30 and/or one or more other examples herein, further comprising receiving, from a gNB, information associated with A-IoT operation, wherein the one or more command messages are transmitted based on the information.

Example 32 may include the method of example 31 and/or one or more other examples herein, further comprising sending A-IoT capability information to a gNB.

Example 33 may include the method of example 32 and/or one or more other examples herein, wherein the A-IoT capability information is sent after the random access procedure is performed.

Example 34 may include a method of an Ambient Internet of Things (A-IoT) device, the method comprising:
receiving a query command associated with a random access procedure;
starting a backoff timer based on receipt of the query command; and
transmitting, upon expiration of the backoff timer, a message that includes a contention resolution ID.

Example 35 may include the method of example 34 and/or one or more other examples herein, further comprising:
receiving an acknowledgement message with the contention resolution ID.

Example 36 may include the method of example 35 and/or one or more other examples herein, further comprising transmitting an acknowledgement response message if the contention resolution ID in the acknowledgement message matches the contention resolution ID transmitted by the A-IoT device.

Example 37 may include the method of example 34-36 and/or one or more other examples herein, further comprising receiving a select command prior to the query command, wherein the select command includes information associated with the random access procedure and/or the query command.

Example 38 may include the method of example 34-37 and/or one or more other examples herein, wherein the query command is transmitted periodically.

Example 39 may include the method of example 34-38 and/or one or more other examples herein, wherein the query command includes an indication of an A-IoT device type that is to perform the random access procedure.

Example 40 may include the method of example 34-39 and/or one or more other examples herein, wherein the query command indicates a value of the backoff timer and/or includes a scaling factor for the backoff timer.

Example 41 may include the method of example 34-40 and/or one or more other examples herein, wherein a value of the backoff timer is randomly generated.

Example 42 may include the method of example 34-41 and/or one or more other examples herein, wherein the message that includes the contention resolution ID further includes an A-IoT device type and/or A-IoT device capability information of the A-IoT device.

Example 43 may include the method of example 34-42 and/or one or more other examples herein, further comprising applying a set of orthogonal cover codes (OCCs) to the message that includes the contention resolution ID.

Example 44 may include the method of example 43 and/or one or more other examples herein, wherein the set of OCCs are predefined.

Example 45 may include the method of example 34-44 and/or one or more other examples herein, wherein the acknowledgement message includes respective contention resolution IDs for multiple A-IoT devices.

Example 46 may include the method of example 34-45 and/or one or more other examples herein, wherein the acknowledgement message further includes scheduling information for the acknowledgement response message.

Example 47 may include the method of example 34-46 and/or one or more other examples herein, wherein the query command is received from a next generation Node B (gNB) or a user equipment (UE).

Example 48 may include the system and method of wireless communication for a fifth generation (5G) or new radio (NR) system:

transmitting, by gNodeB (gNB) or UE, a downlink physical channel or signal to an Ambient Internet of Things (A-IoT) device in accordance with the DL transmission timing from NR system.

Example 49 may include the method of example 48 and/or one or more other examples herein, wherein the DL transmission timing may be symbol, slot or subframe boundary.

Example 50 may include the method of any of examples 48-49, and/or one or more other examples herein, wherein an OFDM symbol in NR may be equally divided to N symbols or chips for a physical channel and/or signal for A-IoT, wherein the boundary of an OFDM symbol may be aligned with the boundary of symbol or chip for a physical channel and/or signal for A-IoT.

Example 51 may include the method of any of examples 48-50, and/or one or more other examples herein, wherein the determination of the symbol or chip duration for A-IoT from OFDM symbol in NR may exclude the cyclic prefix (CP) duration

Example 52 may include the method of any of examples 48-51, and/or one or more other examples herein, wherein the determination of the symbol or chip duration for A-IoT from OFDM symbol in NR may include the cyclic prefix (CP) duration

Example 53 may include the method of any of examples 48-52, and/or one or more other examples herein, wherein physical channel and/or signal for A-IoT may not be transmitted in this 0.52 us duration

Example 54 may include the method of any of examples 48-53, and/or one or more other examples herein, wherein the first part of first symbol for the physical channel and/or signal after 0.52 us is copied to create the longer symbol

Example 55 may include the method of any of examples 48-54, and/or one or more other examples herein, wherein the last part of first symbol for the physical channel and/or signal after 0.52 us is copied to create the longer symbol

Example 56 may include the method of any of examples 48-55, and/or one or more other examples herein, wherein a slot or a subframe in NR may be equally divided into N symbols or chips for a physical channel and/or signal for A-IoT, wherein the boundary of a slot or subframe may be aligned with the boundary of symbol or chip for a physical channel and/or signal for A-IoT.

Example 57 may include the method of any of examples 48-56, and/or one or more other examples herein, wherein starting positioning of a physical channel and/or signal for A-IoT may align with an OFDM symbol boundary, a slot boundary, a subframe boundary or a frame boundary.

Example 58 may include the method of any of examples 48-57, and/or one or more other examples herein, wherein the starting positioning of a physical channel and/or signal for A-IoT may be defined relative to the start of a slot, a subframe or a frame

Example 59 may include the method of any of examples 48-49, and/or one or more other examples herein, wherein more than one slots or subframes can be grouped as reference for time domain resource for physical channel or signal for A-IoT, wherein K slots or subframes may be formed as a bundled slot or a bundled subframe as reference, where K can be predefined in the specification, configured by higher layers, or indicated in the triggering or broadcast command from either gNB or intermediate node

Example 60 may include the method of any of examples 48-58, and/or one or more other examples herein, wherein a physical channel and/or signal may include two part, wherein the first part may be defined as preamble, which may be used for presence detection of the second part or for time and/or frequency synchronization. The second part may be used to carry control information and/or data packet for A-IoT applications

Example 61 may include the method of any of examples 48-59, and/or one or more other examples herein, wherein a physical channel and/or signal may only include one part.

Example 62 may include the method of any of examples 48-60, and/or one or more other examples herein, wherein a physical channel and/or signal may include three parts, wherein the first part may be defined as preamble; the second part may be used to carry control information, which may be used for the scheduling data packet in the third part; the third part may be used to carry data packet.

Example 63 may include the method of any of examples 48-61, and/or one or more other examples herein, wherein preamble and/or postamble may be defined as a physical signal

Example 64 may include a method to be performed by an electronic device associated with a cellular network, wherein the method comprises: identifying a timing associated with a downlink (DL) transmission of the cellular network; identifying a physical channel transmission that is to be transmitted, by the electronic device, to an ambient internet of things (A-IoT) device; and transmitting the physical channel transmission to the A-IoT device based on the timing.

Example 65 may include the method of example 64, and/or one or more other examples herein, wherein the electronic device is a base station, a user equipment (UE), or an integrated access and backhaul (IAB) node of the cellular network.

Example 66 may include the method of any of examples 64-65, and/or one or more other examples herein, wherein the timing is based on a symbol boundary, a slot boundary, or a subframe boundary of the DL transmission.

Example 67 may include the method of any of examples 64-66, and/or one or more other examples herein, wherein transmitting the physical channel transmission to the A-IoT device includes:
dividing an orthogonal frequency division multiplexed (OFDM) symbol associated with the DL transmission into a plurality of sub-symbols; and
aligning, in the time domain, respective symbols of the physical channel transmission with respective ones of the plurality of sub-symbols.

Example 68 may include the method of example 67, and/or one or more other examples herein, wherein a sub-symbol of the DL transmission is based on a cyclic prefix (CP) associated with the DL transmission.

Example 69 may include the method of example 67, and/or one or more other examples herein, wherein a sub-symbol of the DL transmission excludes a cyclic prefix (CP) associated with the DL transmission.

Example 70 may include a method to be performed by a reader of a cellular network, wherein the method comprises: identifying an ambient internet of things (A-IoT) device communicatively coupled with the reader; identifying a boundary in the time domain of an orthogonal frequency division multiplexed (OFDM) symbol of a new radio (NR) cellular transmission; identifying, based on the boundary in the time domain of the OFDM symbol, a boundary in the time domain of an A-IoT symbol of an A-IoT transmission to the A-IoT device; and encoding the A-IoT transmission to the A-IoT device based on the identified boundary in the time domain of the A-IoT symbol.

Example 71 may include the method of example 70, and/or one or more other examples herein, wherein the A-IoT symbol has a shorter duration than the OFDM symbol.

Example 71.5 may include the method of example 71, and/or one or more other example herein, wherein a length of the OFDM symbol is a multiple of a length of the A-IoT symbol.

Example 72 may include the method of any one or more of examples 70-71.5, and/or one or more other examples herein, wherein the boundary in the time domain of the A-IoT symbol is aligned with the boundary in the time domain of the OFDM symbol.

Example 73 may include the method of any one or more of examples 70-72, and/or one or more other examples herein, wherein the boundary in the time domain of the OFDM symbol is further a boundary in the time domain of a downlink (DL) slot of the NR transmission.

Example 74 may include the method of any one or more of examples 70-73, and/or one or more other examples herein, wherein the boundary in the time domain of the OFDM symbol is further a boundary in the time domain of a downlink (DL) subframe of the NR transmission.

Example 75 may include the method of any one or more of examples 70-74, and/or one or more other examples herein, wherein the reader is a base station of the cellular network.

Example 76 may include the method of any one or more of examples 70-75, and/or one or more other examples herein, wherein the reader is a user equipment (UE) of the cellular network.

Example 77 may include a method to be performed by a reader of a cellular network, wherein the method comprises: transmitting, to an ambient internet of things (A-IoT) device, one or more command messages with configuration information for a random access procedure; receiving, from the A-IoT device, a random access message that includes a contention resolution identifier (ID); transmitting, to the A-IoT device, an acknowledgement message with the received contention resolution ID; and receiving, from the A-IoT device based on the acknowledgement message, an acknowledgement response message.

Example 78 may include the method of example 77, and/or one or more other examples herein, wherein the one or more command messages include a select command message or a query command message.

Example 79 may include the method of any one or more of examples 77-78, and/or one or more other examples herein, wherein the acknowledgement response message is based on identification, by the A-IoT device, that the contention resolution ID in the random access message matches the contention resolution ID in the acknowledgement message.

Example 80 may include the method of any one or more of examples 77-79, and/or one or more other examples herein, wherein the random access message is transmitted by the A-IoT device when a backoff counter expires.

Example 81 may include the method of example 80, and/or one or more other examples herein, wherein the backoff counter is a randomly generated value.

Example 82 may include the method of any one or more of examples 77-81, and/or one or more other examples herein, wherein the reader is a user equipment (UE) of the cellular network.

Example 83 may include the method of any one or more of examples 77-82, and/or one or more other examples herein, wherein the reader is a base station of the cellular network.

Example 84 may include a method to be performed by an ambient internet of things (A-IoT) device, wherein the method comprises: identifying, from a reader of a cellular network, one or more command messages with configuration information for a random access procedure; transmitting, to the reader, a random access message that includes a contention resolution identifier (ID); identifying, from the reader, an acknowledgement message with the received contention resolution ID; and transmitting, to the reader based on the acknowledgement message, an acknowledgement response message.

Example 85 may include the method of example 84, and/or one or more other examples herein, wherein the one or more command messages include a select command message or a query command message.

Example 86 may include the method of any one or more of examples 84-85, and/or one or more other examples herein, wherein the method further comprises: comparing the contention resolution ID in the random access message to the contention resolution ID in the acknowledgement message; and transmitting, if the contention resolution ID in the random access message matches the contention resolution ID in the acknowledgement message, the acknowledgement response message.

Example 87 may include the method of any one or more of examples 84-86, and/or one or more other examples herein, further comprising: identifying that a backoff counter has expired; and transmitting the random access message based on the expiration of the backoff counter.

Example 88 may include the method of example 87, and/or one or more other examples herein, wherein the backoff counter is a randomly generated value.

Example 89 may include the method of any one or more of examples 84-88, and/or one or more other examples herein, wherein the reader is a user equipment (UE) of the cellular network.

Example 90 may include the method of any one or more of examples 84-89, and/or one or more other examples herein, wherein the reader is a base station of the cellular network.

Example Z01 may include an apparatus comprising means to perform one or more elements of a method described in or related to any of examples 1-90, and/or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-90, and/or any other method or process described herein.

Example Z03 may include an apparatus comprising logic, modules, or circuitry to perform one or more elements of a method described in or related to any of examples 1-90, and/or any other method or process described herein.

Example Z04 may include a method, technique, or process as described in or related to any of examples 1-90, and/or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-90, and/or portions thereof.

Example Z06 may include a signal as described in or related to any of examples 1-90, or portions or parts thereof.

Example Z07 may include a datagram, packet, frame, segment, protocol data unit (PDU), or message as described in or related to any of examples 1-90, and/or portions or parts thereof, or otherwise described in the present disclosure.

Example Z08 may include a signal encoded with data as described in or related to any of examples 1-90, and/or portions or parts thereof, or otherwise described in the present disclosure.

Example Z09 may include a signal encoded with a datagram, packet, frame, segment, protocol data unit (PDU), or message as described in or related to any of examples 1-90, and/or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-90, and/or portions thereof.

Example Z11 may include a computer program comprising instructions, wherein execution of the program by a processing element is to cause the processing element to carry out the method, techniques, or process as described in or related to any of examples 1-90, and/or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1-20. (canceled)

21. An electronic device to be used in a user equipment (UE), wherein the electronic device comprises:
memory to store information related to a boundary in the time domain of an orthogonal frequency division multiplexed (OFDM) symbol of a new radio (NR) cellular transmission; and
one or more processors configured to:
identify an ambient internet of things (A-IoT) device communicatively coupled with the reader;
identify, based on the boundary in the time domain of the OFDM symbol, a boundary in the time domain of an A-IoT symbol of an A-IoT transmission to the A-IoT device; and
encode the A-IoT transmission to the A-IoT device based on the identified boundary in the time domain of the A-IoT symbol.

22. The electronic device of claim 21, wherein the A-IoT symbol has a shorter duration than the OFDM symbol.

23. The electronic device of claim 22, wherein a length of the OFDM symbol is a multiple of a length of the A-IoT symbol.

24. The electronic device of claim 21, wherein the boundary in the time domain of the A-IoT symbol is aligned with the boundary in the time domain of the OFDM symbol.

25. The electronic device of claim 21, wherein the boundary in the time domain of the OFDM symbol is further a boundary in the time domain of a downlink (DL) slot of the NR transmission.

26. The electronic device of claim 21, wherein the boundary in the time domain of the OFDM symbol is further a boundary in the time domain of a downlink (DL) subframe of the NR transmission.

27. A non-transitory computer-readable storage medium that stores instructions, upon execution of the instructions by one or more processors of an electronic device, are to cause a reader of a cellular network to:
transmit, to an ambient internet of things (A-IoT) device, one or more command messages with configuration information for a random access procedure;
identify, from the A-IoT device, a random access message that includes a contention resolution identifier (ID);
transmit, to the A-IoT device, an acknowledgement message with the received contention resolution ID; and
identify, from the A-IoT device based on the acknowledgement message, an acknowledgement response message.

28. The non-transitory computer-readable storage medium of claim 27, wherein the one or more command messages include a select command message or a query command message.

29. The non-transitory computer-readable storage medium of claim 27, wherein the acknowledgement response message is based on identification, by the A-IoT device, that the contention resolution ID in the random access message matches the contention resolution ID in the acknowledgement message.

30. The non-transitory computer-readable storage medium of claim 27, wherein the random access message is transmitted by the A-IoT device when a backoff counter expires.

31. The non-transitory computer-readable storage medium of claim 30, wherein the backoff counter is a randomly generated value.

32. The non-transitory computer-readable storage medium of claim 31, wherein the reader is a user equipment (UE) of the cellular network.

33. The non-transitory computer-readable storage medium of claim 31, wherein the reader is a base station of the cellular network.

34. An ambient internet of things (A-IoT) device comprising:
memory to store, received from a reader of a cellular network, one or more command messages with configuration information for a random access procedure; and
one or more processors configured to:
encode, for transmission to the reader, a random access message that includes a contention resolution identifier (ID);
identify, from the reader, an acknowledgement message with the received contention resolution ID; and
encode, for transmission to the reader based on the acknowledgement message, an acknowledgement response message.

35. The A-IoT device of claim 34, wherein the one or more command messages include a select command message or a query command message.

36. The A-IoT device of claim 34, wherein the one or more processors are further configured to:
compare the contention resolution ID in the random access message to the contention resolution ID in the acknowledgement message; and
encode, if the contention resolution ID in the random access message matches the contention resolution ID in the acknowledgement message, the acknowledgement response message.

37. The A-IoT device of claim 34, wherein the one or more processors are further configured to:
identify that a backoff counter has expired; and
encode the random access message based on the expiration of the backoff counter.

38. The A-IoT device of claim 37, wherein the backoff counter is a randomly generated value.

39. The A-IoT device of any of claim 38, wherein the reader is a user equipment (UE) of the cellular network

40. The A-IoT device of claim 38, wherein the reader is a base station of the cellular network.
